(19) United States
(12) Patent Application Publication
(10) Pub. No.: US 2025/0261822 A1
(43) Pub. Date: Aug. 21, 2025

(54) DISH WASHER

(71) Applicant: LG Electronics Inc., Seoul (KR)

(72) Inventors: Yongnam KIM, Seoul (KR); Dong Jun CHOI, Seoul (KR); Sangwoog CHO, Seoul (KR); Yeon A JO, Seoul (KR); Sung Hyun PARK, Seoul (KR); Jin Won KANG, Seoul (KR); Min Kyu OH, Seoul (KR)

(21) Appl. No.: 19/036,412

(22) Filed: Jan. 24, 2025

(30) Foreign Application Priority Data
Feb. 16, 2024 (KR) 10-2024-0022973

(51) Int. Cl. A47L 15/42

(52) U.S. Cl. CPC A47L 15/4257

(57) ABSTRACT

A dish washer is configured such that, when a handle of a door does not automatically pop up in a situation where power may not be supplied to the dish washer or a situation where power supply thereto is cut off, a user is able to manually partially pop up the handle and move the handle to an extended position, so that the user can open the door effectively even in the emergency situation, and convenience of the user can be improved.

### CROSS-REFERENCE TO RELATED APPLICATION

This application claims priority to and benefit of Korean Patent Application No. 10-2024-0022973, filed on Feb. 16, 2024, which is hereby incorporated by reference as when fully set forth herein.

### TECHNICAL FIELD

The present disclosure relates to a dish washer. More specifically, the present disclosure relates to a dish washer configured such that, when a door should be opened in an emergency situation but a handle does not automatically pop up, such as a situation where power may not be supplied to the dish washer or a situation where power supply thereto is cut off, a user is able to manually partially pop up a handle and manually move the handle to an extended position, so that the door may be opened effectively even in the emergency situation and convenience of the user may be improved.

### BACKGROUND

A dish washer is an apparatus that washes dishes and cooking utensils as washing targets stored therein by spraying washing water thereto. The washing water may contain washing detergent.

Using the dish washer may allow a time and effort for washing the dishes and other washing targets after a meal to be reduced, thereby contributing to user convenience.

In order to store dishes inside the dish washer before a washing cycle, and to withdraw the washed and dried dishes after the washing cycle, the user should open and close the door.

The dish washer may include a door that is provided with a handle that the user may grasp to open and close the door.

In some cases, a dish washer may include a depressed type handle which the user grasps provided in the door. For instance, the handle of the dish washer may be provided in a form of a grip groove configured to be depressed from a front surface of the door toward a rear surface thereof by a predetermined depth. The handle may be provided in a depressed form from a portion of the front surface of the door toward an inside of the door. In some cases, a separate cover, etc., may not be disposed on the handle, and thus the handle may be always exposed to an outside. In some cases, the handle structure may accumulate external foreign substances such as dusts in the depressed space into which the hand of the user is inserted. The user may frequently clean the handle, thereby causing inconvenience to the user. In some cases, the handle may deteriorate the aesthetic sense of the front surface appearance of the door because the portion of the front surface of the door is concavely depressed.

In some cases, a dish washer may include a protruding type handle disposed on the door. For example, the handle may have a predetermined protruding height in a frontward direction from a front surface of the door, and may be always in a protruding state and have a 90 degrees-rotated U shape. In some cases, a user who does not recognize the protruding portion from the front surface of the door may collide with the protruding portion, thereby causing injury to the user. In some cases, the handle may collide with dishes and other kitchenware when the dishes are withdrawn from the dish washer and thus there is a possibility of causing damage to the handle itself or items such as dishes.

### SUMMARY

The present disclosure describes a dish washer configured such that the handle is configured to extend in a protruding manner in a frontward direction from the door, such as when opening or closing the door, so that external foreign substances such as dusts are prevented from accumulating on the handle, thereby maintaining a clean state of the handle and improving user convenience.

The present disclosure further describes a dish washer configured such that the handle is configured to at least partially retract into an inside of the door when the use of the handle is not used, and a front end surface of the handle and a front surface of the door are configured to be coplanar with each other in the retracted state such that the user feels a sense of unity of the handle and the door with each other, thereby improving the aesthetics of the appearance of the dish washer.

The present disclosure further describes a dish washer configured such that the handle is configured to at least partially retract into the inside of the door when the handle is not used, thereby reducing the possibility of user injury and handle damage that may occur due to collision of the user with the handle.

The present disclosure further describes a dish washer configured such that when a door should be opened in an emergency situation where a handle does not automatically pop up, such as a situation where power cannot be supplied to the dish washer or a situation where power supply thereto is cut off, a user is able to manually partially pop up a handle and manually move the handle to an extended position, so that the door may be opened effectively even in the emergency situation and convenience of the user may be improved.

According to one aspect of the subject matter described in this application, a dish washer includes a tub that defines a washing space configured to accommodate one or more objects to be washed therein, the tub having an open front surface in fluid communication with the washing space, a door configured to open and close the open front surface of the tub, a handle configured to reciprocate between (i) an extended position in which the handle protrudes forward from the door and (ii) a retracted position in which the handle is accommodated within the door, a handle driver disposed within the door and configured to reciprocate the handle from the retracted position toward the extended position or from the extended position toward the retracted position, and a pop-up device configured to, based on the handle being stopped at the retracted position, move the handle to a pop-up position in which the handle at least partially protrudes from an inside of the door toward an outside of the door. The pop-up device is configured to, based on the handle being retracted rearwardly toward the inside of the door by a predetermined retract stroke from the retracted position, move the handle to the pop-up position.

Implementations according to this aspect can include one or more of the following features. For example, the handle may include a handle body configured to reciprocate between the extended position and the retracted position based on a driving force of the handle driver, and a sliding block connected to the handle body and configured to move relative to the handle body, the sliding block being configured to transmit the driving force of the handle driver to the handle body, where the pop-up device is configured to, based on the handle being retracted rearwardly by the predetermined retract stroke from the retracted position, move the handle body relative to the sliding block in a frontward direction toward the outside of the door to thereby pop up the handle body relative to a surface of the door.

In some implementations, the pop-up device may include a latch fixed to the handle body, and a latch holder fixed to the sliding block and removably coupled to the latch, where the latch holder may include a compression spring configured to press the latch in the frontward direction toward the outside of the door. In some examples, the compression spring may be configured to, based on the handle body moving relative to the sliding block rearwards toward the inside of the door by the predetermined retract stroke, push and move the latch in the frontward direction toward the outside of the door. In some examples, the pop-up device may be configured to release an engagement between the latch and the latch holder before the latch moves in the frontward direction by force from the compression spring.

In some examples, the latch and the latch holder are configured to be re-engaged with each other based on the handle body being retracted rearwards toward the inside of the door. In some examples, the latch and the latch holder are configured to, based on being re-engaged with each other, restrict the handle body from moving relative to the sliding block in the frontward direction toward the outside of the door.

In some implementations, the handle body may include a first body that extends in a left-right direction and is configured to be gripped by a user, and a second body that extends rearwards from the first body and defines an inner space configured to receive the sliding block therein, where the second body may include an inner panel that is disposed in the inner space and that divides the inner space into a front space and a rear space, the inner panel having a protruding surface that is convex toward the sliding block, and the latch is fixed to the protruding surface. In some examples, the latch holder may be fixedly disposed in an interior space of the sliding block. In some examples, the protruding surface of the second body may be configured to be retracted into the interior space of the sliding block based on the handle body being moved rearwards relative to the sliding block toward the inside of the door by the predetermined retract stroke.

In some implementations, the handle further may include a pop-up blocker configured to allow the handle body to pop up relative to the surface of the door and to restrict the handle body from popping up relative to the surface of the door, wherein the pop-up blocker is configured to, based on the handle being moved to the retracted position, allow the handle body to pop up relative to the surface of the door, and based on the handle being moved to the extended position, restrict the handle body from popping up relative to the surface of the door.

In some examples, the pop-up blocker may be disposed inside the handle body and configured to move relative to the handle body, where the handle body may include a stopper protrusion that is disposed at an inner surface of the handle body and positioned in front of the pop-up blocker, the stopper protrusion being spaced apart from the pop-up blocker. The stopper protrusion may be configured to limit a relative movement of the handle body relative to the pop-up blocker, and the handle body may be configured to, based on the handle being moved to the retracted position, define a first spacing between the stopper protrusion and the pop-up blocker in a frontward-backward direction. For example, a width of the first spacing is greater than the predetermined retract stroke.

In some examples, the handle body may be configured to, based on the handle being moved to the extended position, define a second spacing between the stopper protrusion and the pop-up blocker in the frontward-backward direction. For instance, a width of the second spacing is less than the predetermined retract stroke.

In some implementations, the handle driver may be configured to, based a user being detected within a predetermined range from the door, move the handle from the retracted position to the extended position. In some examples, the pop-up device may be configured to, based on a user pressing the handle at the retracted position, move the handle from the retracted position to the pop-up position.

In some implementations, the pop-up position is the extended position. In some examples, the handle is configured to be flush with a front surface of the door based on the handle being located at the retracted position. In some examples, the pop-up device may be one of a plurality of pop-up devices that are disposed at lateral end portions of the handle.

In some implementations, external foreign substances such as dusts may be prevented from accumulating on the handle, thereby maintaining a clean state of the handle and improving user convenience.

In some implementations, in the retracted state of the handle, the user feels a sense of unity of the handle and the door with each other, thereby improving the aesthetics of the appearance of the dish washer.

In some implementations, the dish washer may reduce the possibility of user injury and handle damage that may occur due to collision of the user with the handle.

In some implementations, when the door should be opened in an emergency situation where a handle does not automatically pop up, such as a situation where power cannot be supplied to the dish washer or a situation where power supply thereto is cut off, the user may be able to manually partially pop up the handle and manually move the handle to the extended position, so that the door may be opened effectively even in the emergency situation and convenience of the user may be improved.

In addition to the above-mentioned effects, the specific effects of the present disclosure as not mentioned will be described below along with the descriptions of the specific details for carrying out the present disclosure.

### BRIEF DESCRIPTION OF DRAWINGS

FIG. 1 is a front perspective view showing an example of a dish washer.

FIG. 2 is a schematic cross-sectional view of the dish washer as shown in FIG. 1.

FIG. 3 is a front perspective view showing an example state in which a handle of a dish washer has been displaced to a retracted position.

FIG. 4 is a front perspective view showing an example state in which the handle as shown in FIG. 3 has been displaced to an extended position.

FIG. 5 is an enlarged side view of FIG. 3.

FIG. 6 is a schematic diagram illustrating an example configuration for recognizing a user and a pet in a distinguishing manner from each other using a proximity sensor disposed on a top surface of a door to determine the user's intention to open the door.

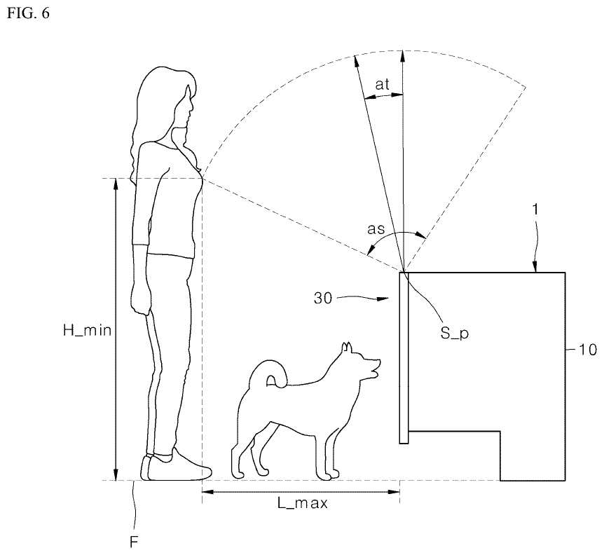

FIG. 7 is a rear perspective view of the door as shown in FIG. 3 and shows an example state in which a rear panel of the door is removed.

FIG. 8 is a rear perspective view showing an example of a handle driver as shown in FIG. 7.

FIG. 9 is an exploded perspective view of the handle driver as shown in FIG. 7.

FIG. 10 is an exploded perspective view showing an example of a pivot link, a link connector, and a connection pin among components of the handle driver as shown in FIG. 9.

FIG. 11 is a side view illustrating an example operation of the handle driver to initiate movement from the retracted position to the extended position for the handle.

FIG. 12 is a side view illustrating an example state in which movement to the extended position of the handle has been completed.

FIG. 13 is a side view illustrating an example operation of the handle driver to initiate movement from the extended position to the retracted position of the handle.

FIG. 14 is an enlarged view of a portion of FIG. 12, and is a diagram illustrating an example structure that prevents the handle from being moved backwards under an external force applied to the handle.

FIG. 15 is a rear perspective view illustrating an example of a handle frame on which the handle and the handle driver are installed which supports the handle and the handle driver.

FIG. 16 is an exploded perspective view for illustrating an example configuration of the handle.

FIG. 17 is an exploded perspective view showing an example of a manual pop-up device and a pop-up blocker provided in the handle as illustrated in FIG. 16.

FIG. 18 is a vertical cross-sectional view of the handle and the handle driver illustrating a state in which the handle has been displaced to the retracted position.

FIG. 19 is an enlarged view of a portion of FIG. 18.

FIG. 20 is a front perspective view of the door, and is a diagram illustrating an example position to which a user's pressing pressure is input for the manual pop-up of the handle.

FIG. 21 is a vertical cross-sectional view of the handle and the handle driver illustrating an example state in which the handle has been manually moved to the extended position by the user after the manual pop-up of the handle.

FIG. 22 is a vertical cross-sectional view of the handle and the handle driver illustrating an example state in which the handle has been automatically moved to the extended position.

FIG. 23 is an enlarged view of a portion of FIG. 22.

### DETAILED DESCRIPTIONS

The above-mentioned purpose, features and advantages are described in detail below with reference to the attached drawings. Accordingly, a person skilled in the art in the technical field to which the present disclosure belongs will be able to easily implement the technical idea of the present disclosure. In describing the present disclosure, when it is determined that a detailed description of the known technology related to the present disclosure may unnecessarily obscure the gist of the present disclosure, the detailed description thereof is omitted. Hereinafter, one or more implementations will be described in detail with reference to the attached drawings. In the drawings, identical reference numerals are used to indicate identical or similar components.

Hereinafter, an overall structure of a dish washer 1 will be described in detail with reference to the attached drawings.

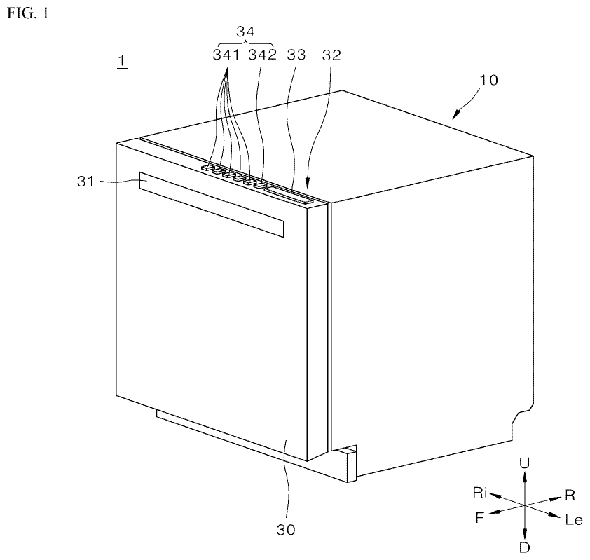

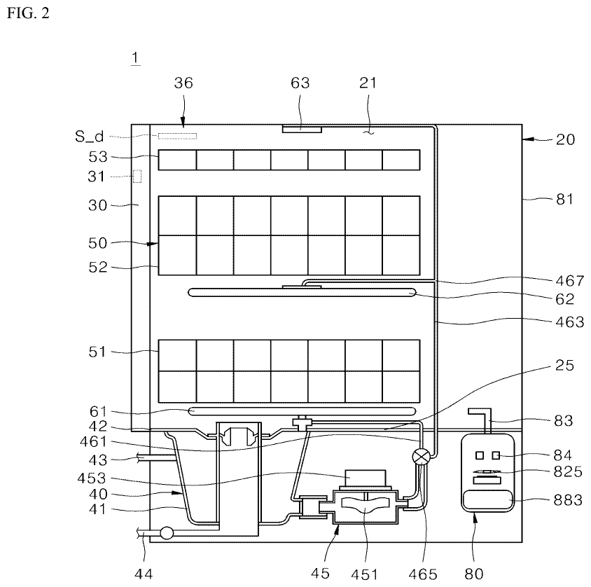

FIG. 1 is a front perspective view showing an example of the dish washer 1. FIG. 2 is a simplified cross-sectional view briefly showing an internal structure of the dish washer 1.

In some implementations, as shown in FIG. 1 and FIG. 2, the dish washer 1 may include a casing 10 that constitutes an exterior appearance, a tub 20 installed in an inner space of the casing 10 and having a washing space 21 defined therein where the washing target is washed, wherein a front surface of the tub is open, a door 30 that opens/closes the open front surface of the tub 20, a driver 40 located under the tub 20 to supply, collect, circulate, and discharge the washing water for washing the washing target, a dish rack 50 removably provided in the inner washing space 21 of the tub 20 to receive therein the washing target, and a water sprayer installed adjacent to the dish rack 50 to spray the washing water for washing the washing target thereto.

In some examples, the washing target received in the dish rack 50 may be, for example, dishes such as bowls, plates, spoons, and chopsticks, and other cooking utensils. Hereinafter, unless otherwise specified, the washing target will be referred to as a dish.

The tub 20 may be formed in a box shape with an open front surface, and have a configuration of a so-referred to as washing tub.

The washing space 21 may be defined inside the tub 20. The open front surface of the tub 20 may be opened/closing by the door 30.

The tub 20 may be formed via pressing of a metal plate resistant to high temperature and moisture, for example, a stainless steel plate.

Moreover, on an inner surface of the tub 20, a plurality of brackets may be disposed for the purpose of supporting and installing functional components such as the dish rack 50 and the water sprayer which will be described later thereon within the tub 20.

In one example, the driver 40 may include a sump 41 that stores therein washing water, a sump cover 42 that distinguishes the sump 41 from the tub 20, a water supply 43 that supplies washing water from an external source to the sump 41, a water discharger 44 that discharges the washing water of the sump 41 to an outside, and a washing pump 45 and a supply flow path 46 that supply the washing water of the sump 41 to the water sprayer. The sump cover 42 may be disposed at a top of the sump 41 and may serve to distinguish the tub 20 and the sump 41 from each other.

Moreover, the sump cover 42 may have a plurality of collecting holes defined therein for collecting washing water sprayed into the washing space 21 through the water sprayer into the sump 41.

That is, the washing water sprayed from the water sprayer toward the dish may fall down to a bottom of the washing space 21, and may be collected again through the sump cover 42 and into the sump 41.

The washing pump 45 may be disposed at one side of the sump 41 and may serve to pressurize the washing water and supply the pressurized washing water to the water sprayer.

One end of the washing pump 45 may be connected to the sump 41 and the other end thereof may be connected to the supply flow path 46. The washing pump 45 may be equipped with an impeller 451 and a motor 453. When power is supplied to the motor 453, the impeller 451 may rotate, and thus the washing water in the sump 41 may be pressurized, and then may be supplied to the water sprayer through the supply flow path 46.

In some examples, a wash water heater may be provided in the washing pump 45 to heat the wash water supplied during a wash cycle or a heat rinse cycle.

In one example, the supply flow path 46 may serve to selectively supply the washing water supplied from the washing pump 45 to the water sprayer.

For example, the supply flow path 46 may include a first supply flow path 461 connected to a lower spraying arm 61, and a second supply flow path 463 connected to an upper spraying arm 62 and a top nozzle 63. The supply flow path 46 may be provided with a supply flow path switching valve 465 that selectively opens/closes the supply flow paths 461 and 463.

In some implementations, the supply flow path switching valve 465 may be controlled so that the supply flow paths 461 and 463 are opened sequentially or simultaneously.

In one example, the water sprayer may be configured to spray the washing water to the dishes stored in the dish rack 50.

More specifically, the water sprayer may include the lower spraying arm 61 located under the tub 20 to spray the washing water to a lower rack 51, the upper spraying arm 62 located between the lower rack 51 and an upper rack 52 to spray the washing water to the lower rack 51 and the upper rack 52, and the top nozzle 63 located on top of the tub 20 to spray the washing water to a top rack 53 or the upper rack 52.

In particular, the lower spraying arm 61 and the upper spraying arm 62 may be rotatably disposed in the washing space 21 of the tub 20 and may spray the washing water toward the dish of the dish rack 50 while being rotating.

The lower spraying arm 61 may be rotatably supported on a top of the sump cover 42 so as to spray the washing water toward the lower rack 51 while being rotating and being disposed under the lower rack 51.

Moreover, the upper spraying arm 62 may be rotatably supported by a spraying arm holder 467 so as to spray the washing water on the dish while being rotating and being disposed between the lower rack 51 and the upper rack 52.

In some examples, in order to increase washing efficiency, additional means for diverting the washing water sprayed from the lower spraying arm 61 into an upward direction (diverting in a U-direction) may be provided at a lower surface 25 of the tub 20.

A detailed configuration of the water sprayer has been already known in the art. Thus, a description of the specific configuration of the water sprayer will be omitted below.

The dish rack 50 for storing the dish therein may be disposed in the washing space 21.

The dish rack 50 may be configured to extend or retract from or into the inner space of the tub 20 through the open front surface of the tub 20.

For example, in FIG. 2, the dish rack 50 may include the lower rack 51 located at a lower portion of the tub 20 to accommodate therein relatively large dishes, the upper rack 5 located on top of the lower rack 51 to accommodate therein medium-sized dishes, and the top rack 53 located at a top level of the tub 20 and capable of storing therein small dishes, etc. However, implementations of present disclosure are not limited thereto. Hereinafter, an example in which the dish washer 1 includes the three dish racks 50 as shown is described.

In some implementations, each of the lower rack 51, the upper rack 52, and the top rack 53 may be configured to extend or retract from or into the inner space of the tub 20 through the open front surface of the tub 20.

For this purpose, guide rails may be respectively disposed on both opposing inner side surfaces constituting an inner surface of the tub 20. By way of example, the guide rails may include an upper rail, a lower rail, and a top rail.

Wheels may be disposed on a bottom of each of the lower rack 51, the upper rack 52, and the top rack 53. The user may extend the lower rack 51, the upper rack 52, and the top rack 53 from the inner space of the tub 20 through the open front surface of the tub 20 and may place the dishes thereon, or easily withdraw the dishes that have been washed out thereof.

The guide rail may be implemented as a simple rail-type fixed guide rail to guide the extending or the retracting of the rack 50, or a telescopic guide rail capable of guiding the extending or the retracting of the rack 50 and at the same time, increasing an extension distance thereof as the rack 50 further extends from the inner space of the tub.

In one example, the door 30 is configured for opening/closing the open front surface of the tub 20 as described above.

A hinge around which the door 30 is closed or opened may be provided at a bottom of the open front surface. Thus, the door 30 may pivot around the hinge as a pivot axis.

In some implementations, a handle 31 for opening the door 30 and a control panel 32 for controlling an operation of the dish washer 1 may be disposed on an outer side surface of the door 30.

As shown, the control panel 32 may include a display 33 that visually displays information regarding a current operating status of the dish washer 1, etc., and a button unit 34 including a selection button through which a user's course selection manipulation is input and a power button through which a user's manipulation for turning the dish washer on and off is input.

In one example, a rear panel 30b constituting an inner side surface of the door 30 may constitute one surface of the tub 20 when the door 30 has been closed, and may constitute a seat surface on which the lower rack 51 of the dish rack 50 is supported when the door 30 is fully opened.

For this purpose, when the door 30 is fully opened downwardly, the rear panel 30b of the door 30 may constitute a horizontal plane extending in the same direction as a direction in which the guide rail guiding the displacement of the lower rack 51 extends.

In one example, unlike a conventional handle, the handle 31 of the dish washer 1 may be configured to be at least partially accommodated in an inside of the door 30 when the handle is not in use, and to automatically extend in a protruding manner in a frontward direction from the door 30 when it is necessary to open and close the door 30.

In that the handle is configured to retract so as to be at least partially accommodated in the inside of the door 30 or extend in a protruding manner in a frontward direction from the door 30 out of the inside of the door 30, the handle 31 may be referred to as various names such as a pop-up handle, a retractable handle, an extendable handle, etc.

Hereinafter, the handle 31 configured to retract into or extend from the door 30 of the dish washer 1 will be referred to as the pop-up handle 31.

In some examples, the rear panel 30b defining the inside of the door 30 may further be provided with a detergent supply device for automatically supplying detergent into the inside of the tub 20.

Furthermore, a door position sensor 36 may be disposed on an outer top surface of the tub 20 and may be configured to detect whether the door 30 is in a closed or open state. For example, the door position sensor 36 may include a door position sensor S_d or a latch sensor that detects a position of a door latch.

In one example, a drying air supply 80 may be disposed under the tub 20 and may be configured to generate and supply high-temperature or low-temperature drying air to the washing space inside the tub 20.

As shown, the drying air supply 80 may be configured to include a filter member 883 for filtering outside air, a blower fan 825 for generating a drying air stream, a heater 84 for heating the drying air stream, and an air stream guide 83 disposed inside the tub 20 so as to guide the drying air stream.

A drying air supply hole may be defined in a lower surface of the tub 20 so that high-temperature drying air generated by the drying air supply 80 may be introduced into the inside of the tub 20 through the drying air supply hole.

Thus, the high-temperature drying air or low-temperature drying air may be supplied from the drying air supply 80 into the inside of the tub 20 during the drying cycle S5 such that the drying efficiency and sterilization effect on the dishes may be improved compared to a conventional dish washer.

In one example, the dish washer may be configured such that the air current supplied to the inside of the tub 20 and moistened while drying the dishes may be discharged to the outside, and the discharge of the air current may be accomplished via partial opening of the door 30 or via a separate air discharge means.

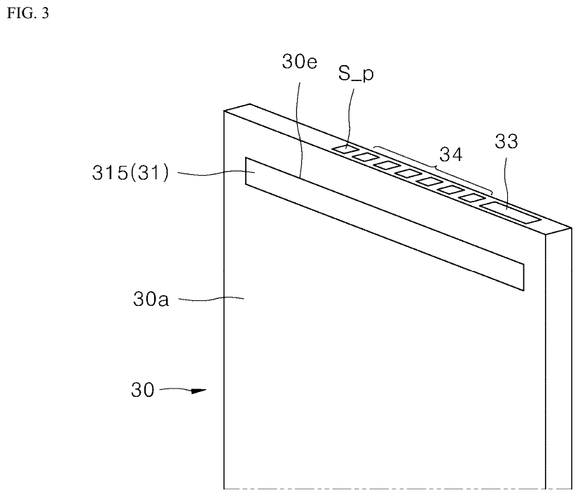

Hereinafter, with reference to FIGS. 3 to 5, the appearance and the operation of the pop-up handle 31 disposed at the door 30 of the dish washer 1 will be described in detail.

As described above, the door 30 of the dish washer 1 may be provided with the pop-up handle 31 that may be reciprocally movable.

In some implementations, as described above, the door 30 may be configured to be pivotable around the hinge connected to a lower end of the door.

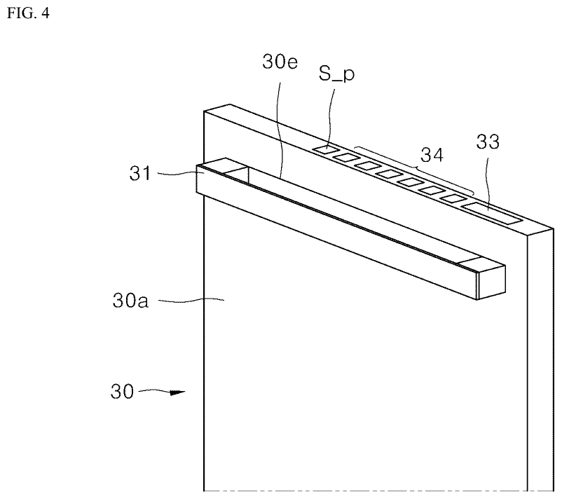

In consideration of the position of the hinge, as shown in FIG. 3 and FIG. 4, the pop-up handle 31 may be positioned at a position close to a top surface of the door 30 where the user may easily grasp the handle, and may be disposed at the front panel 30a constituting the front surface of the door 30.

Furthermore, the pop-up handle 31 may extend along an extension direction of a front edge of the top surface of the door 30 and along a left-right direction so that the user may easily grasp the handle. The handle 31 may be formed to have an approximate 90 degrees-rotated U shape.

In order to extend or retract the pop-up handle 31, an elongate opening 30e having a shape corresponding to an appearance of the pop-up handle 31 may be defined in the front panel 30a of the door 30 and extend along the extension direction of the front edge of the top surface of the door 30, and have a depth along a front-rear (F-R) direction

The pop-up handle 31 may be configured to reciprocate along the forward and backward directions through the opening 30e of the front panel 30a under an operation of a handle driver 35 as described below.

More specifically, the pop-up handle 31 may be disposed to reciprocate between the most forward position and the most rearward position under the operation of the handle driver 35.

For convenience, the most forward position to which the pop-up handle 31 is displaced in a forward direction is defined as an extended position Pd. The most rearward position to which the pop-up handle 31 is displaced in a backward direction is defined as a retracted position Pa.

FIG. 3 illustrates a state where the pop-up handle 31 has been displaced to the most rearward position, that is, the retracted position Pa, and thus has been retracted into the inside of the door 30.

As shown, when the pop-up handle 31 has been displaced to the retracted position Pa, the pop-up handle 31 has been at least partially retracted into the inside of the door 30.

In some examples, the pop-up handle 31 may pass through an entirety of the opening 30e of the door 30 and be retracted into the inside of the door 30.

Furthermore, when the pop-up handle 31 has been displaced to the retracted position Pa, the pop-up handle 31 may be in a state where the pop-up handle 31 does not protrude from the front panel 30a of the door 30 in a frontward direction.

Furthermore, when the pop-up handle 31 has been displaced to the retracted position Pa, a front end surface of the pop-up handle 31 may be coplanar with a front surface of the front panel 30a of the door 30 so as to form a continuous surface.

That is, no step may be formed between the front surface of the front panel 30a of the door 30 and the front end surface of the pop-up handle 31 when the pop-up handle 31 has been displaced to the retracted position Pa.

Thus, when the pop-up handle 31 has been displaced to the retracted position Pa, the opening 30e of the front panel 30a is entirely blocked, and at the same time, no step is formed between the front surface of the front panel 30a and the front end surface of the pop-up handle 31, such that the phenomenon in which foreign substances such as dusts accumulate on an convex portion of the door 30 or on the handle itself as in the conventional approach may be prevented.

In one example, as described below, the front end surface of the pop-up handle 31 may be a front surface of a decoration panel 315 that is provided separately from the handle body 311 that constitute the overall appearance of the pop-up handle 31.

In some implementations, the decoration panel 315 may include a material having the same texture as that of the front panel 30a of the door 30.

Thus, the user may feel a sense of unity the decoration panel 315 and the front panel 30a of the door 30, and thus the aesthetic sensibility of the outer appearance of the door 30 may be improved and the aesthetics of the door which the user perceives may be improved.

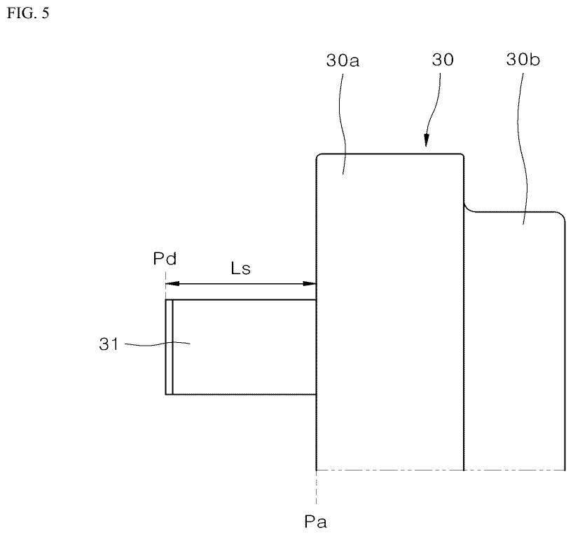

FIG. 4 and FIG. 5 illustrate a state in which the pop-up handle 31 has been displaced from the retracted position Pa to the extended position Pd as the most forward position.

As described above, the door 30 of the dish washer 1 should be opened and closed in order to store the dishes that need to be washed in the dish washer or to withdraw the dishes that have been washed out of the dish washer 1.

When the user's intention to open the door 30 is identified at a time for opening/closing of the door 30, the pop-up handle 31 may be automatically moved from the retracted position Pa to the extended position Pd under the operation of the handle driver 35.

For this purpose, the dish washer 1 may further be provided with a means for detecting the user's intention to open the door 30.

For example, the means for detecting the user's intention to open the door 30 may include a proximity sensor S_p.

The proximity sensor S_p may be a sensor that may detect whether the user approached so as to be located within a specific range from the door 30.

For example, the proximity sensor S_p may include any one of a radar sensor, an image sensor, or an infrared sensor (IR) Sensor.

However, implementations of the present disclosure are not limited thereto, and the proximity sensor S_p may be applied without limitation in terms of the type thereof as long as the proximity sensor S_p is a means that can identify proximity of the user to the door. The following description will be based on an example in which the radar sensor is applied as the proximity sensor S_p.

As shown in FIG. 3 and FIG. 4, the radar sensor as the proximity sensor S_p may be disposed on the control panel 32 and at a location close to the existing display 33 so as to easily identify the proximity of the user to the door, and to facilitate modularization thereof with the existing display 33.

In this way, the radar sensor as the proximity sensor S_p may be disposed on the control panel 32 disposed on the top surface of the door 30 and may be configured to recognize the user and a pet that is not the user in the distinguishing manner from each other.

However, the dish washer 1 is not configured to immediately move the pop-up handle 31 even when the radar sensor recognizes that the user is located within a predetermined distance range from the door 30.

This is because there may be cases where the user simply passes by the dish washer 1 without any intention to open the door 30.

In some examples, the dish washer 1 may be further configured to add a time condition to identify the intention to open the door 30 through the proximity sensor S_p such as the radar sensor.

In some examples, when the dish washer 1 identifies that the user is present within a specific distance range from the door 30 through the radar sensor and continues to stay within the specific distance range for a specific time condition, the dish washer 1 may determine that the user has an intention to open the door 30.

In some implementations, the specific distance range and the specific time condition may be set to vary depending on the environment in which the dish washer 1 is disposed and a physical condition of the user.

When the specific distance range condition and the specific time condition are satisfied, the operation of the handle driver 35 may be initiated and the pop-up handle 31 may be displaced forwardly from the retracted position Pa to the extended position Pd.

FIG. 4 and FIG. 5 illustrate the state in which the pop-up handle 31 has completed the forward movement to the extended position Pd.

When the pop-up handle 31 has completed its movement to the extended position Pd, the handle body 311 of the pop-up handle 31 may be exposed to the outside of the door 30 and may be grasped by the user.

In some implementations, a stroke Ls by which the pop-up handle 31 is displaced from the retracted position Pa to the extended position Pd may be in a range of 40 mm inclusive to 50 mm inclusive, for example, 45 mm.

The stroke Ls of the pop-up handle 31 is determined in consideration of that when the stroke Ls is too small, such as smaller than 40 mm, it is not easy for the user to grasp the handle, while when the stroke Ls is too large, such as larger than 50 mm, a size of the pop-up handle 31 in the forward and backward direction increases, thereby causing a problem in that the pop-up handle 31 does not retract entirely into the door 30.

However, the numerical value of the movement stroke Ls of the pop-up handle 31 is only an example and may be set to vary depending on the overall size of the dish washer 1 and the size in the forward and backward direction of the door 30.

FIG. 5 discloses a configuration that detects the user's intention to open the door 30 using a single radar sensor as a proximity sensor S_p.

As known in the art, the radar sensor may transmit the electromagnetic waves from a sensing surface thereof and may receive the electromagnetic waves reflected from the user or the object and may analyze the received electromagnetic waves and may perform a function of detecting the presence of the user or the object within a detection area as, a distance to the user or the object, and a moving speed of the user or the object based on the analysis result.

As illustrated, the detection area as of the radar sensor applied to the present disclosure may have an angular range of about 100 degrees along the frontward-backward direction and about 100 degrees along the left-right direction around the sensing surface.

In some implementations, as described above, the radar sensor functioning as the proximity sensor S_p may be configured to be disposed at a position as close as possible to a center of a top surface of the front panel 30a of the door 30 defining the inside of the door 30 so as to easily identify whether the user is approaching an area in front of the door 30 and to distinguish between the user and a non-user such as a pet from each other.

Furthermore, as shown in FIG. 5, since the radar sensor is positioned inside the door 30 and near the top surface of the front panel 30a of the door 30, the sensing surface of the radar sensor may be oriented to generally face upwardly of the door 30.

Furthermore, the sensing surface of the radar sensor may be oriented to be tilted at a predetermined angle in a frontward direction of the door 30.

Accordingly, the sensing surface of the radar sensor may be oriented in a frontward and upward direction of the door 30.

In this way, since the sensing surface of the radar sensor is oriented to be tilted so as to face in a frontward and upward direction rather than in a frontward and downward direction of the door 30, the detection area as of the radar sensor may have a line tilted so as to face in a frontward and upward direction of the door 30.

Since the sensing surface of the radar sensor is oriented to be tilted so as to face in a frontward and upward direction of the door 30 while being disposed in a tilting holder. Thus, even when an object that cannot be expected to use the dish washer 1, such as a pet or an infant with a height smaller than at least the dish washer 1, approaches an area in front of the door 30, the radar sensor may be configured not to detect the pet or infant.

Accordingly, upon detecting the pet or the infant, the pop-up handle may be prevented from operating meaninglessly, and thus power loss may be minimized.

In some examples, the tilting angle at of the sensing surface of the radar sensor with respect to the vertical direction may be, for example, in a range of 25 degrees inclusive to 35 degrees inclusive, for example, 30 degrees.

However, the tilting angle at of the sensing surface of the radar sensor provided in the present disclosure with respect to the vertical direction may be adjusted according to the physical condition of the user who is expected to use the dish washer 1.

For example, when the tilting angle at of the sensing surface of the radar sensor with respect to the vertical direction is set to 30 degrees, a minimum vertical detection height H_min of the radar sensor may be in a range of 100 cm inclusive to 110 cm inclusive, for example, 105 cm, and a maximum detection distance L_max based on the horizontal direction may be in a range of 75 cm inclusive to 85 cm inclusive, for example, 80 cm.

That is, when the tilting angle at is set to 30 degrees, a user with a height of 105 cm or larger may be recognized as approaching the door when he or she enters the detection range within 80 cm from the radar sensor based on the horizontal direction.

Alternatively, for example, when the tilt angle at is set to 15 degrees, a user with a height of 127 cm or more may be recognized as approaching to the door when he or she enters the detection range within 50 cm of the radar sensor in the horizontal direction.

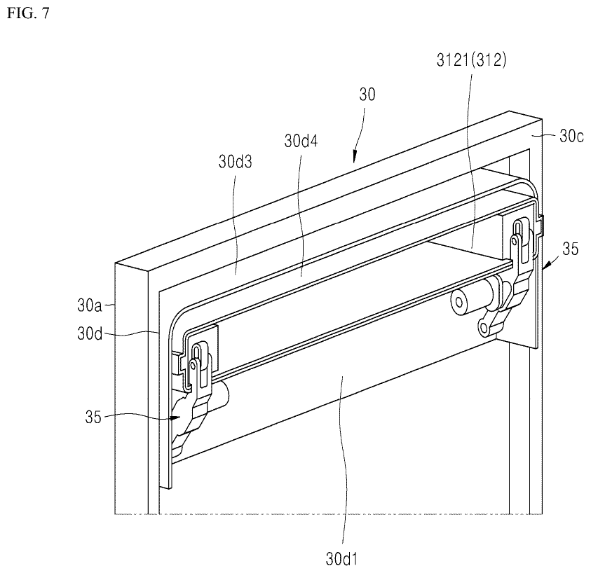

Hereinafter, referring to FIG. 7 to FIG. 14, the detailed configuration of the handle driver 35 that actuates the pop-up handle 31 so that the pop-up handle 31 moves back and forth between the extended position Pd and the retracted position Pa is described.

In some implementations, referring to FIG. 7, in consideration of a shape of the handle body 311 of the pop-up handle 31 that extends in an elongate manner in the left-right direction, a pair of handle drivers 35 may be disposed separately and respectively on a left end and a right end of the pop-up handle 31.

That is, the pair of handle drivers 35 may be separated from each other and spaced from each other along the left-right direction and may be respectively on a left end and a right end of the pop-up handle 31 so as to respectively transmit a driving force for moving the pop-up handle 31 to the left end and the right end of the pop-up handle 31 which are accommodated inside a handle housing 30d4.

In this way, the pair of handle drivers 35 are disposed in a state separated from each other and spaced form each other along the left-right direction, the driving force generated from each of the handle drivers 35 may be transmitted to each of the left and right ends of the pop-up handle 31.

Accordingly, since driving loads applied to the handle drivers 35 are distributed, the miniaturization of each of the handle drivers 35 may be achieved, and thus, the manufacturing cost may be reduced.

However, this is only an example. Alternatively, the pop-up handle 31 may be driven using only a single handle driver. Hereinafter, an example in which the pair of handle drivers 35 are provided will be described. However, implementations of present disclosure are not limited thereto.

As illustrated, the left handle driver 35 and the right handle driver 35 may have shapes symmetrical with each other and may be arranged symmetrically with each other around the pop-up handle 31, and may be fixedly installed on a handle frame 30d.

Therefore, the right and left handle drivers 35 may be configured to be identical with each other except for the fact that the left handle driver 35 and the right handle driver 35 have shapes symmetrical with each other and are arranged symmetrically with each other around the pop-up handle 31.

Therefore, the following description will be based on the handle driver 35 disposed at the left side. Unless otherwise described, the following content may be equally applied to the handle driver 35 disposed at the right side.

As shown in FIG. 7 to FIG. 9, the handle driver 35 that generates the driving force for the reciprocating movement of the pop-up handle 31 may be configured to include a driving motor 351 that receives power and generates a rotational driving force, a driving cam 352 that spins under the rotational driving force of the driving motor 351, a pivot link 353 that pivots around one end thereof in conjunction with the spin motion of the driving cam 352 so as to push or pull the pop-up handle 31, a link connector 354 that connects the pivot link 353 and the pop-up handle 31 to each other, and a housing 355 that accommodates therein the driving motor 351, the driving cam 352, and the pivot link 353.

The driving motor 351 is configured to receive power and generate a rotational driving force.

As described above, the pop-up handle 31 may be configured to repeatedly move forwards from the retracted position Pa toward the extended position Pd and move backwards from the extended position Pd toward the retracted position Pa and thus to reciprocate between the extended position Pd and the retracted position Pa.

In order to easily implement such reciprocating movement, the driving motor 351 constituting the handle driver 35 may be configured to generate a bidirectional rotation driving force.

Accordingly, the driving motor 351 applied to the handle driver 35 may be applied without limitation in terms of the type thereof as long as the driving motor 351 is capable of generating the bidirectional rotation driving force.

Hereinafter, among the bidirectional rotation driving (forces), the driving (driving force) in the direction in which an output shaft 3512 of the driving motor 351 rotates to move the pop-up handle 31 in the frontward direction toward the extended position Pd is referred to as forward direction rotation driving (forward direction rotation driving force), while the driving (driving force) in the direction in which the output shaft 3512 of the driving motor 351 rotates to move the pop-up handle 31 backwards toward the retracted position Pa is referred to as reverse direction rotation driving (or reverse direction rotation driving force).

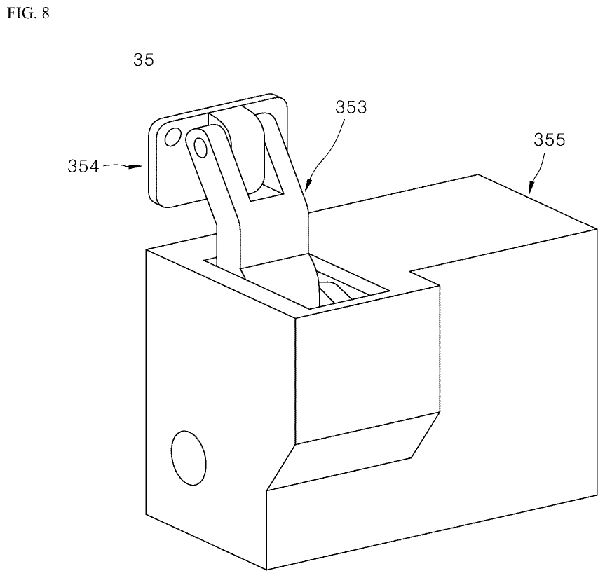

In one example, as shown in FIG. 8, a motor body 3511 of the driving motor 351 may be accommodated in an accommodation space formed between a second housing 3552 and a third housing 3553, and the output shaft 3512 of the driving motor 351 may extend thorough the second housing 3552 and be connected to the driving cam 352.

As described below, the output shaft 3512 of the driving motor 351 may be inserted into a shaft hole 3522 of the driving cam 352, and may be forcibly coupled to the shaft hole 3522.

Thus, the output shaft 3512 of the driving motor 351 may rotate integrally with the driving cam 352.

In one example, the driving cam 352 receives the rotation driving force from the output shaft 3512 of the driving motor 351 and transmits the received rotation driving force to the pivot link 353.

More specifically, when the driving cam 352 rotates in the forward direction in conjunction with the rotation of the output shaft 3512 of the driving motor 351, the driving cam 352 pressurizes the pivot link 353 so that the pivot link 353 pivots in the frontward direction. When the driving cam 352 rotates in the reverse direction in conjunction with the rotation of the output shaft 3512 of the driving motor 351, the driving cam 352 pressurizes the pivot link 353 so that the pivot link 353 pivots in the backward direction.

For this purpose, the driving cam 352 may be configured to include a cam body 3521 that spins under the rotation driving force transmitted from the output shaft 3512 of the driving motor 351, and a driving pin 3523 that is disposed on one side surface of the cam body 3521 and protrudes toward the pivot link 353.

The cam body 3521 may be provided in a form of a disk having an approximately uniform thickness, for example.

The shaft hole 3522 to which the output shaft 3512 of the driving motor 351 is forcibly inserted may extend through a center portion of the cam body 3521.

In order to easily implement integral rotation of the cam body 3521 and the motor shaft 3512 via the forcible coupling between the output shaft 3512 and the shaft hole 3522, the output shaft 3512 and the shaft hole 3522 may be connected to each other via a spline coupling, etc.

In one example, the driving pin 3523 plays a role of transmitting the rotation driving force of the cam body 3521 to the pivot link 353.

As illustrated, the driving pin 3523 may be formed to protrude from one side surface facing the pivot link of the cam body 3521 toward the pivot link 353, and may be positioned at a position spaced apart from the shaft hole 3522 by a predetermined distance in a radial direction.

Therefore, when the cam body 3521 spins around the shaft hole 3522, the driving pin 3523 revolves around the shaft hole 3522.

The driving pin 3523 is connected to the pivot link 353 while being inserted into a guide groove 3533 of the pivot link 353 as described later.

Accordingly, while the driving pin 3523 revolves around the shaft hole of the cam body 3521, the driving pin 3523 pressurizes the pivot link 353 so that the pivot link 353 pivots in a frontward or backward direction.

In one example, a revolve range of the driving pin 3523 or a spin range of the cam body 3521 needs to be smaller than an extension length of the guide groove 3533 provided in the pivot link 353. This is because when the revolve range is larger than the extension length of the guide groove 3533, there is a possibility that the driving pin 3523 or the guide groove 3533 may be damaged.

In some implementations, a stopper protrusion 3524 may be configured to limit the revolve range of the driving pin 3523, or the spin range of the cam body 3521 may be disposed on an edge of the cam body 3521 and protrude along a radial direction thereof.

As illustrated, the stopper protrusion 3524 may be implemented as a predetermined step formed on the edge of the cam body 3521.

The stopper protrusion 3524 implemented as the step may be provided as a pair of stopper protrusions spaced apart from each other along a circumferential direction of the cam body which may limit the revolve range of the driving pin 3523 or the spin range of the cam body 3521 in both opposing directions.

In this way, the stopper protrusion 3524 may limit the revolve range of the driving pin 3523 or the spin range of the cam body 3521 to a circumferential range defined between the pair of stopper protrusions 3524.

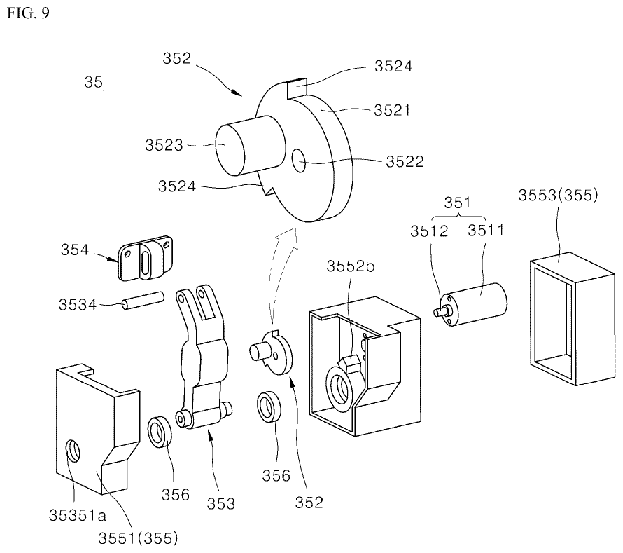

As shown in FIG. 9, a cam stopper 3552b corresponding to the pair of stopper protrusions 3524 may be provided inside the second housing 3552 that accommodates the driving cam 352.

In one example, the pivot link 353 receives the driving force from the driving pin 3523 of the driving cam 352 so as to push the pop-up handle 31 so that the pop-up handle 31 moves forwards or pull the pop-up handle 31 so that the pop-up handle 31 moves backwards.

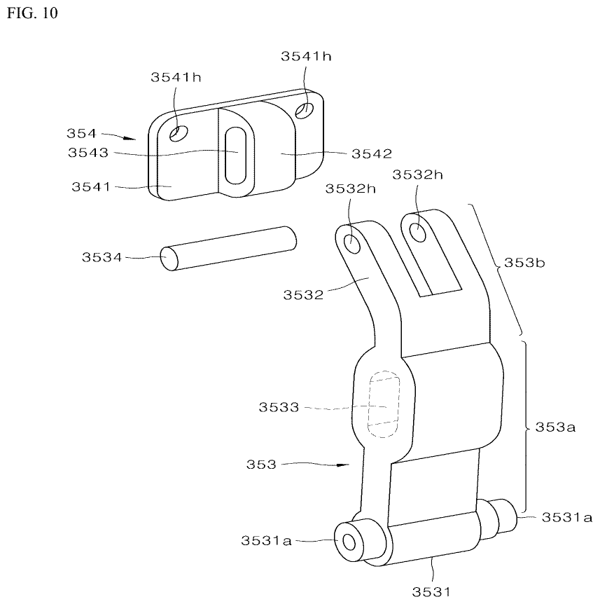

As shown in FIG. 10, the pivot link 353 may be, for example, a bar-type link extending from a first end 3531 toward a second end 3532 thereof in a bar shape.

In some examples, the first end 3531 of the pivot link 353 as the bar-type link may be supported by the first housing 3551 and the second housing 3552 such that the pivot link only relatively rotates with respect to the first housing 3551 and the second housing 3552, that is, only pivots with respect to the first housing 3551 and the second housing 3552.

Accordingly, the pivot link 353 may pivot around the first end 3531 when the pressing force of the driving pin 3523 of the driving cam 352 is applied thereto.

For this purpose, a pair of shaft bosses 3531a that serve as a pivot center of an entirety of the pivot link 353 may be provided at both opposing sides of the first end 3531 of the pivot link 353, respectively.

The pair of shaft bosses 3531a may be formed to protrude toward the first housing 3551 and the second housing 3552 so as to have a predetermined protrusion height from one side surface and the other side surface of the first end 3531 of the pivot link 353, respectively.

A bushing 356 or a bearing may be fitted around each of the pair of shaft bosses 3531a to reduce friction. The pair of shaft bosses 3531a may be connected to the first housing 3551 and the second housing 3552, respectively, while each bushing 356 is fitted around each of the pair of shaft bosses 3531a.

Each of the first housing 3551 and the second housing 3552 may be formed to have a cylindrical bushing receiving portion into which the bushing 356 may be inserted.

The pivot link 353 may be formed to have the guide groove 3533 into which the driving pin 3523 of the driving cam 352 as described above is inserted.

As illustrated, the guide groove 3533 may be formed between the first end 3531 and the second end 3532, and may be defined in a first extension 353a of the pivot link 353 as described below.

The guide groove 3533 may linearly extend along a length direction of the first extension 353a. Movement of the driving pin 3523 may be guided along the extension direction of the guide groove 3533 so that the driving pin 3523 moves relative to the guide groove 3533 while being inserted into the guide groove 3533.

In one example, the second end 3532 of the pivot link 353 may be connected to the handle body 311 of the pop-up handle 31 so as to be relatively movable with respect thereto, and may be configured to move the pop-up handle 31 forwards or backwards by pushing or pulling the handle body 311 when the pivot link 353 pivots.

The second end 3532 of the pivot link 353 may be connected to the handle body 311 via a connection pin 3534 so that the second end 3532 of the pivot link 353 may move relative to the handle body 311. More specifically, the second end 3532 may be connected to a sliding block 316 disposed inside the handle body 311.

In some examples, the link connector 354 may be further provided as a component for mutually connecting the second end 3532 of the pivot link 353 and the sliding block 316 of the handle body 311 to each other.

As illustrated, in one example, the link connector 354 may be configured to include a handle connection portion 3541 that is fastened to the sliding block 316 as described below, and a link connection portion 3542 that is indirectly connected to the second end 3532 via the connection pin 3534.

The handle connection portion 3541 may be formed in a flat shape so as to make surface contact with the sliding block 316 in order to secure a maximum contact area with the sliding block 316.

The handle connection portion 3541 may be formed to have a plurality of screw holes 3541h defined therein so that a connecting means such as a screw bolt may pass through each screw hole.

The link connection portion 3542 may be indirectly connected to the second end 3532 of the pivot link 353 via the connection pin 3534.

For this purpose, a pin guide hole 3543 may be formed in the link connection portion 3542 and extend through the link connection portion along the left-right direction.

As illustrated, the pin guide hole 3543 may linearly extend along the vertical direction. The movement of the connection pin 3534 may be guided so that the connection pin moves relative to the pin guide hole 3543 in the vertical direction while being inserted into the pin guide hole 3543.

Therefore, when the pivot link 353 pivots, the connection pin 3534 coupled to the second end 3532 of the pivot link 353 moves along the pin guide hole 3543, thereby pushing the link connector 354 forwards or pulling the link connector backwards, thereby causing the pop-up handle 31 to move forwards or backwards.

In order to allow the connection pin 3534 to be connected in this way, left and right pin holes 3532h through which the connection pin 3534 passes may extend through the second end 3532 of the pivot link 353 along the left-right direction and may be arranged along the left-right direction.

Furthermore, the second end 3532 of the pivot link 353 may be formed in a branched form as illustrated in order to prevent interference with the link connection portion 3542 that moves relative to the second end 3532.

In one example, as described above, the pivot link 353 pivots around the first end 3531 to push or pull the link connector 354 and the sliding block 316 to generate the forward or backward movement stroke Ls of the pop-up handle 31.

In order to minimize a pivot amount of the pivot link 353 and maximize the frontward-backward movement stroke Ls of the pop-up handle 31, the second end 3532 of the pivot link 353 may extend in an inclined manner in the frontward direction toward the pop-up handle 31.

That is, as shown in FIG. 10, the pivot link 353 may include a first extension 353a that extends radially from the first end 3531, and a second extension 353b that extends in a bent manner toward the pop-up handle 31 and between the first extension 353a and the second end 3532.

In this way, the second extension 353b is formed to be bent or curved toward the pop-up handle 31, thereby greatly increasing the stroke Ls by which the pop-up handle 31 is pushed or pulled.

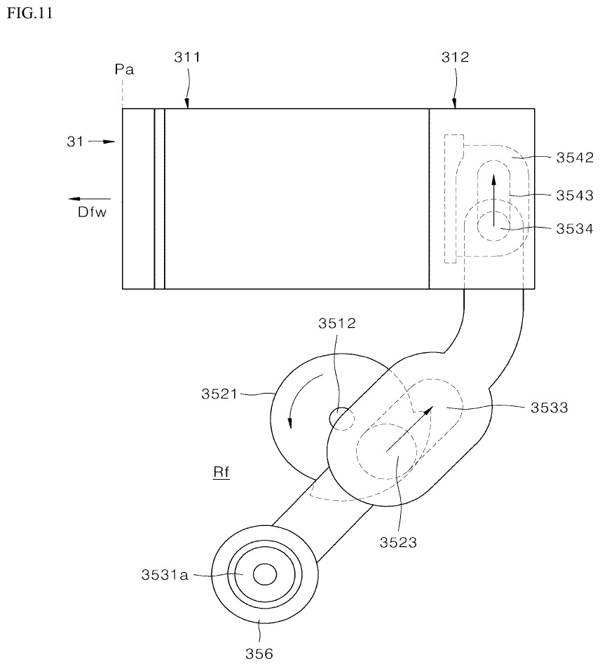

Referring to FIG. 11 to FIG. 14, a process in which the pop-up handle 31 moves forwards to the extended position Pd or moves backwards to the retracted position Pa under the operation of the handle driver 35 will be described below.

In some implementations, FIG. 11 illustrates a situation in which the pop-up handle 31 automatically moves forwards along the forward direction Dfw from the retracted position Pa toward the extended position Pd.

Referring to FIG. 11, when the pop-up handle 31 has been displaced to the retracted position Pa and has been in a stopped state, the power is supplied to the driving motor 351, such that the operation of the driving motor 351 is initiated, and the driving motor 351 generates the forward direction rotation driving force.

Accordingly, the forward direction rotation of the output shaft 3512 of the driving motor 351 may be initiated, and the forward direction spin of the driving cam 352 forcibly connected to the output shaft 3512 may be initiated.

At this time, when the forward direction rotation is initiated, the output shaft 3512 and the driving cam 352 may start to rotate counterclockwise based on the illustrated state.

In one example, as the forward direction spin of the driving cam 352 is initiated, a forward direction revolution of the driving pin 3523 may be initiated.

As shown in FIG. 11, the driving pin 3523 which has been located at a lower end of the guide groove 3533 of the pivot link 353 may start to move to a top of the guide groove 3533.

As the driving pin 3523 revolves in the forward direction, the driving pin moves to the top from the bottom of the guide groove 3533, such that the driving pin 3523 presses the pivot link 353 such that the pivot link pivots forwards around the first end 3531 That is, based on the illustrated state, the pivot link 353 pivots counterclockwise around the first end 3531.

At this time, as the pivot link 353 pivots around the first end 3531, the second end 3532 of the pivot link 353 also pivots forwards, and the connection pin 3534 connected to the second end 3532 pivots forwards.

Accordingly, the driving pin 3523 which has been located at the bottom of the guide hole 3543 of the link connector 354 moves to the top of the guide hole 3543.

As the connection pin 3534 moves to the top from the bottom of the guide hole 3543, the connection pin 3534 presses the link connector 354 and the sliding block 316 to push forwards. That is, while the connection pin 3534 moves relative to the guide hole 3543 and along the guide hole 3543, a pressure force is applied to the link connector 354 to push the link connector 354 forwards.

In this way, the operation of the handle driver 35 is initiated, such that the driving cam 352 has completely rotated along a preset rotation range. Then, the power supply to the driving motor 351 may be cut off, and the forward movement of the pop-up handle 31 to the extended position Pd may be completed.

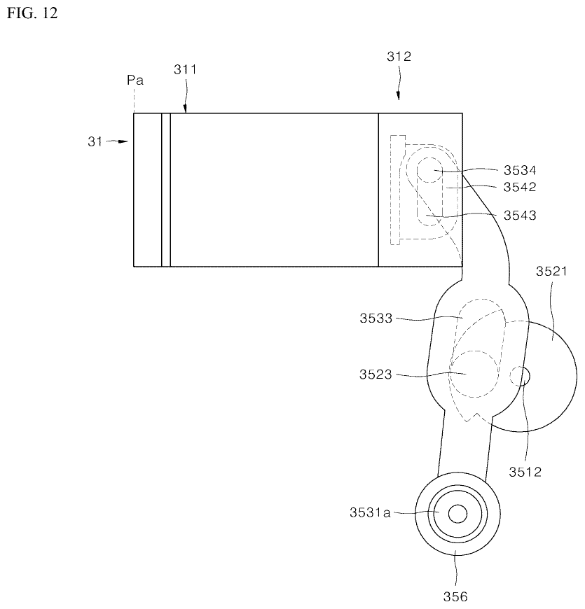

FIG. 12 shows the state in which the pop-up handle 31 has completed the forward movement to the extended position Pd and has stopped.

When the forward movement of the pop-up handle 31 to the extended position Pd has been completed in this way, an entirety of the handle body 311 may be exposed to the outside of the door 30, and thus, the user may easily perform the action of opening or closing the door 30 while holding the handle body 311.

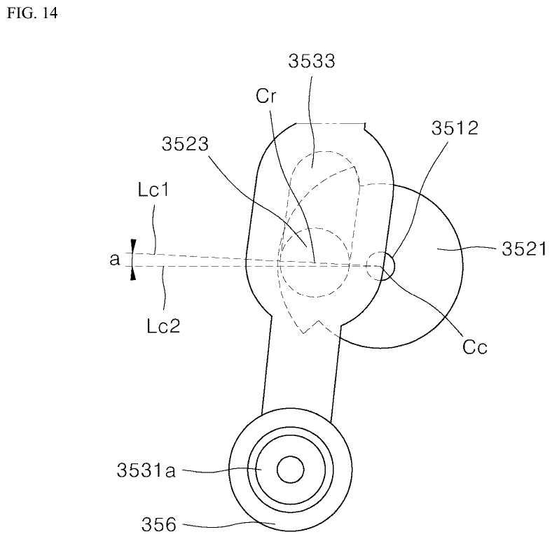

In some examples, as shown in FIG. 14, when the pop-up handle 31 has been displaced to the extended position Pd, the first extension 353a of the pivot link 353 has stood upright, and the driving pin 3523 of the driving cam 352 has been moved to the bottom of the guide groove 3533.

Therefore, as shown, a predetermined intersection angle a may be defined between a virtual first extension line Lc1 connecting a center Cr of the driving pin 3523 and a rotation center Cc of the shaft hole 3522 as a rotation center of the cam body 3521 and a virtual second extension line Lc2 which is parallel to a moving direction Drw/Dfw of the pop-up handle 31 and passes through the rotation center Cc of the shaft hole 3522 of the cam body 3521. However, the intersection angle a may be very small angle.

For example, the intersection angle a may be in a range of 0 degrees inclusive to 5 degrees inclusive.

The very small intersection angle a in a range of 5 degrees or smaller is defined in this way. Thus, a structure may be achieved in which the handle body 311 is fixed at the extended position Pd without being removed from the extended position Pd even when a user's pressure to open or close the door 30 is applied to the handle body 311 of the pop-up handle 31.

That is, a structure in which the pop-up handle 31 may be effectively fixed at the extended position Pd may be achieved by means of a position arrangement of the pivot link 353 and the driving cam 352 while a separate fixing means is not disposed at the pop-up handle 31 and the handle frame 30d as described below.

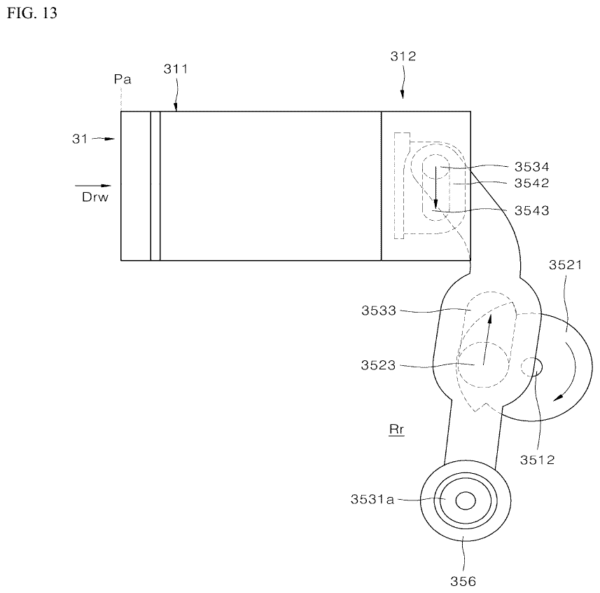

FIG. 13 illustrates a situation in which the pop-up handle 31 automatically moves backwards along the backward direction Drw from the extended position Pd toward the retracted position Pa.

Referring to FIG. 13, the pop-up handle 31 has moved to the extended position Pd and has stopped. Then, after a predetermined waiting time has elapsed, the power is supplied to the driving motor 351, the driving motor 351 starts operating, and the driving motor 351 generates the reverse rotation driving force.

Accordingly, the reverse rotation of the output shaft 3512 of the driving motor 351 starts, and the reverse spin of the driving cam 352 forcibly connected to the output shaft 3512 may start.

When the reverse rotation starts, the output shaft 3512 and the driving cam 352 may start to rotate clockwise based on the illustrated state.

Further, as the reverse spin of the driving cam 352 starts, the reverse revolution of the driving pin 3523 may start.

As shown, the driving pin 3523 which has been positioned at the bottom of the guide groove 3533 of the pivot link 353 may start to move relative to the guide groove 3533 and to the top of the guide groove 3533.

As the driving pin 3523 revolves in the reverse direction, the driving pin moves relative to the guide groove 3533 and to the top from the bottom of the guide groove 3533, the driving pin 3523 presses the pivot link 353 to pivot in the rearward direction around the first end 3531. That is, based on the shown state, the pivot link 353 pivots clockwise around the first end 3531.

In some examples, as the pivot link 353 pivots around the first end 3531, the second end 3532 of the pivot link 353 also pivots in the rearward direction, and the connection pin 3534 connected to the second end 3532 pivots in the rearward direction.

Accordingly, the driving pin 3523 which has been located at the top of the guide hole 3543 of the link connector 354 moves relative to the guide hole 3543 and to the bottom of the guide hole 3543.

As the connection pin 3534 moves relative to the guide hole 3543 and from the top to the bottom of the guide hole 3543, the connection pin 3534 applies the pressure the link connector 354 to pull the link connector 354 in the rearward direction. That is, while the connection pin 3534 moves relative to and along the guide hole 3543, a pressure force is applied to the link connector 354 to pull the link connector 354 in the rearward direction.

In this way, the operation of the handle driver 35 has been initiated, and then, the driving cam 352 has completed the reverse pivot motion thereof along the preset rotation range. Then, the power supply to the driving motor 351 may be cut off, and the backward movement of the pop-up handle 31 to the retracted position Pa may have been completed.

As described above, the pop-up handle 31 is configured to move forwards or backwards under the forward direction driving force or the reverse direction driving force of the handle driver 35.

However, as described above, the pop-up handle 31 may be configured to move horizontally or linearly along the forward direction Dfw or the backward direction Drw.

A means for implementing the horizontal or linear movement may be provided in the pop-up handle 31 and the handle frame 30d in which the pop-up handle 31 is accommodated.

As described above, the pop-up handle 31 may be configured to include the handle body 311 that is exposed to the outside of the door 30 when having moved to the extended position Pd and thus is brought into a state in which the user can grip the handle body.

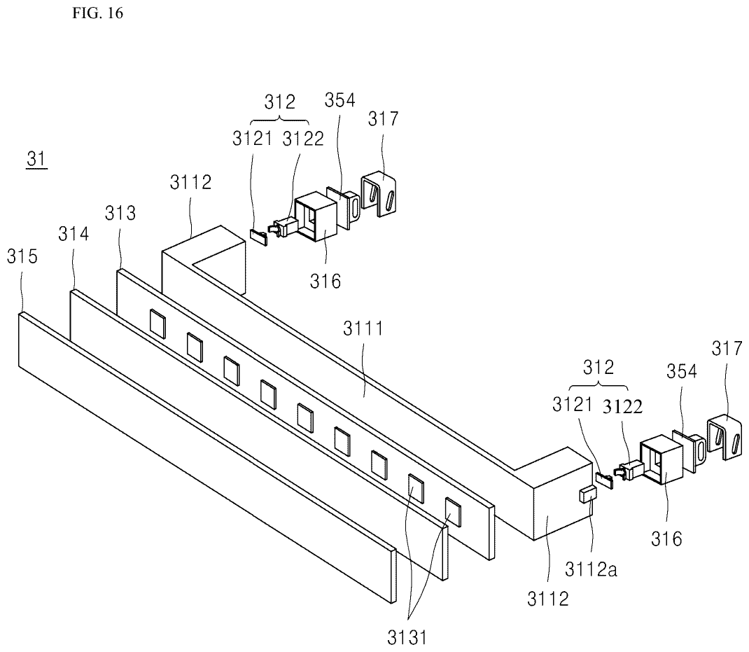

More specifically, as shown in FIG. 16, the handle body 311 may include a first body 3111 that extends along the left-right direction and is configured to be grasped by the user when the user intends to open or close the door 30, and a second body 3112 that extends rearwards from the first body 3111 and has a hollow shape.

In some examples, the second body 3112 incudes a pair of second bodies 3112 which may be integrally connected to both opposing ends of the first body 3111, respectively so as to form the approximate 90-degrees rotated U shape.

In some examples, guide protrusions 3112a that protrude in left and right directions, respectively may be disposed on outer side surfaces of the pair of second bodies 3112, respectively.

As shown, the guide protrusion 3112a may have a shape having a uniform thickness in the vertical direction and may extend along a direction parallel to the forward direction Dfw or the backward direction Drw of the pop-up handle 31.

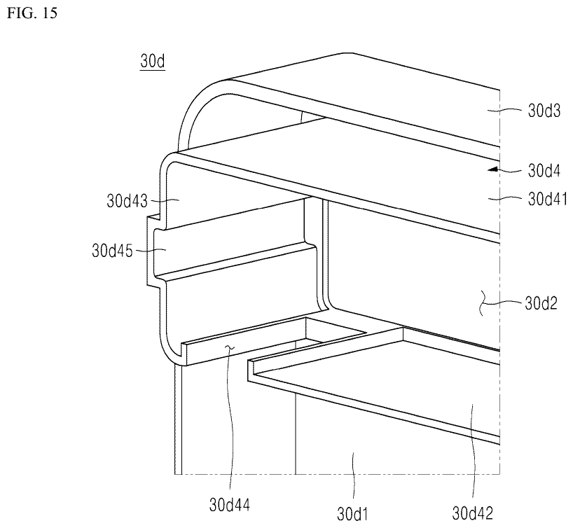

FIG. 15 illustrates the handle frame 30d including a handle housing 30d4 in which the handle body 311 is relatively movably accommodated.

The handle frame 30d may include a panel portion 30d1 and an outer wall 30d3 that serve as a support surface or an attachment surface to support the handle driver 35 thereon.

The panel portion 30d1 and the outer wall 30d3 of the handle frame 30d may be fixed to an inner surface of the front panel 30a or an inner panel 30c of the door 30.

In one example, the handle frame 30d may further include the handle housing 30d4 to movably accommodate therein and support thereon the pop-up handle 31.

As shown in FIG. 15, the handle housing 30d4 may have a rail groove 30d45 defined therein into which the guide protrusion 3112a of the handle body 311 is inserted.

The rail groove 30d45 may be formed in each of left and right side surfaces of the handle housing 30d4, and may be defined by partially protruding each of the left and right side surfaces thereof toward the outer wall 30d3.

Accordingly, in a state in which the guide protrusion 3112a has been inserted into the rail groove 30d45, the handle body 311 may move horizontally or linearly as the guide protrusion 3112a moves along the rail groove 30d45.

In one example, as illustrated, the handle housing 30d4 may be provided in a box shape with a front surface and a rear surface open so as to accommodate an entirety of the handle body 311 when the pop-up handle 31 has been displaced to the retracted position Pa.

The open front surface of the handle housing 30d4 may act as an opening 30d2 through which the handle body 311 extends or retracts.

The opening 30d2 of the first handle housing 30d4 may be formed at a position corresponding to a position of the opening 30e of the front panel 30a of the door 30 and may have a corresponding size to a size thereof.

In one example, as illustrated, a cut-away 30d44 may be defined in a lower surface 30d42 of the handle housing 30d4 to provide a movement path of the pivot link 353 of the handle driver 35. However, a cut-away may not be formed in an upper surface 30d41 of the handle housing 30d4 so as to have a plate shape in order to maintain the rigidity of the handle housing 30d4.

FIG. 16 illustrates a detailed configuration of the aforementioned pop-up handle 31.

Referring to FIG. 16, the pop-up handle 31 provided in the dish washer 1 may further include a handle substrate 313 that is disposed on a front surface of the handle body 311 and has at least one light-source element 3131 mounted thereon, a light-guide plate 314 that is disposed in front of the handle substrate 313 and diffuses visible light generated from the light-source element 3131, and the decoration panel 315 that is disposed in front of the light-guide plate 314.

The light-source element 3131 generates visible light or another type of light when the pop-up handle 31 moves, thereby visually notifying the user that the pop-up handle 31 is operating normally.

The light-source element 3131 may be applied without limitation in terms of the type thereof as the light-source element 3131 may receive power and generate predetermined visible light. In one example, the light-source element 3131 may be an LED (light emitting diode) element.

The following description will be based on an example in which the LED element is applied as the light-source element 3131. However, implementations of the present disclosure are not limited thereto.

FIG. 16 illustrates a configuration in which a total of 9 LED elements are mounted on the handle substrate 313. However, implementations of the present disclosure are not limited thereto, and the number of LED elements may be increased or decreased depending on a size and a shape of the first handle body 311.

In one example, the light-guide plate 314 serves to diffuse the visible light generated from the light-source element 3131.

More specifically, the visible light generated from the light-source element 3131 may be introduced into the light-guide plate 314 through a rear surface of the light-guide plate 314. Then, the visible light received inside the light-guide plate 314 may be spread therein such that the visible light diffuses toward an edge of the light-guide plate 314.

In some examples, the decoration panel 315 disposed in front of the light-guide plate 314 may be surface-treated to have the same texture as that of the front panel 30a of the door 30 as described above.

Therefore, the visible light introduced into the light-guide plate 314 cannot pass through the decoration panel 315 and may be projected to the outside through the edge of the light-guide plate 314.

In order to project the visible light, the edge of the light-guide plate 314 may be exposed to the outside.

That is, the light-guide plate 314 may be positioned so as to be sandwiched between the decoration panel 315 and the front surface of the handle body 311, while the edge of the light-guide plate 314 may not be covered with the decoration panel 315 and the front surface of the handle body 311.

Therefore, as illustrated, the light generated from the light-source element 3131 may travel through the inside of the light-guide plate 314 and then through the edge of the light-guide plate 314 and then may be effectively projected to the outside. Thus, the user may effectively identify an operating state of the pop-up handle 31 based on the optical light projected through the edge of the light-guide plate 314.

Furthermore, since the visible light is projected only through the edge of the light-guide plate 314, a lighting effect similar to indirect lighting may be achieved, thereby improving aesthetic sensibility for the user.

In one example, the pop-up handle 31 of the dish washer 1 may further include a manual pop-up device 312 configured to manually pop up the handle body 311.

As described above, the pop-up handle 31 provided in the dish washer 1 automatically moves using the power supplied to the handle driver 35.

Therefore, in a situation where the pop-up handle 31 cannot move automatically, such as in a situation where power cannot be supplied to the handle driver 35 due to a power outage, a situation where the dish washer 1 is in a location where it cannot be connected to an external power source and thus, power supply to the handle driver 35 is cut off, or a situation where the handle driver 35 malfunctions, when the pop-up handle 31 is fixedly stopped at the retracted position Pa, the user cannot open the door 30 using the pop-up handle 31.

The dish washer 1 may be equipped with the manual pop-up device 312 configured to manually move the pop-up handle 31 from the retracted position Pa to a pop-up position. For instance, the pop-up position is the extended position Pd. In some examples, the pop-up position may be between the retracted position Pa and the extended position Pd. In some examples, the pop-up position may be located forward relative to the extended position Pd.

For example, the manual pop-up device 312 may be configured to include a latch 3121 fixed to the handle body 311 and a latch holder 3122 fixed to the sliding block 316.

The latches 3121 and the latch holder 3122 are configured to be removably coupled to each other, and may be components known in the art as a latch switch, a pop-up switch, a push button, etc.

Therefore, as known to the skilled person to the art, in a state in which the latch 3121 and the latch holder 3122 have been mutually coupled to each other, a pressure force is applied to the latch 3121 so that the latch 3121 is retracted into the inside of the latch holder 3122. Thus, the coupling between the latch 3121 and the latch holder 3122 may be cancelled. Thus, the latch 3121 may be configured to bounce in an opposite direction to a direction of the pressure force under a restoring force of a compression spring 3122c disposed inside the latch holder 3122.

A minimum pressurized movement amount to deactivate or re-activate the engagement state between the latch 3121 and the latch holder 3122 may be defined as a retract stroke.

For example, the retract stroke may be in a range of 2.3 mm to 2.7 mm, for example, 2.5 mm.

In some examples, the handle body 311 is disposed in the handle housing 30d4 in a state in which the handle body can move relative to the sliding block 316 which is forcibly connected to the link connector 354 of the handle driver 35.

Therefore, when the connection between the latch 3121 and the latch holder 3122 has been removed, the handle body 311 is brought into a state where it may move relative to the handle housing 30d4 and the sliding block 316. Thus, the restoring force of the compression spring 3122c may be transmitted to the handle body 311 through the latch 3121, and thus a front portion of the handle body 311 may partially pop-up out of the front panel 30a of the door 30.

When the front portion of the handle body 311 has partially popped up out of the front panel 30a of the door 30, the user may manually move the pop-up handle 31 by grasping the popped-up portion with a finger or tool and moving the pop-up handle forwards to the extended position Pd.

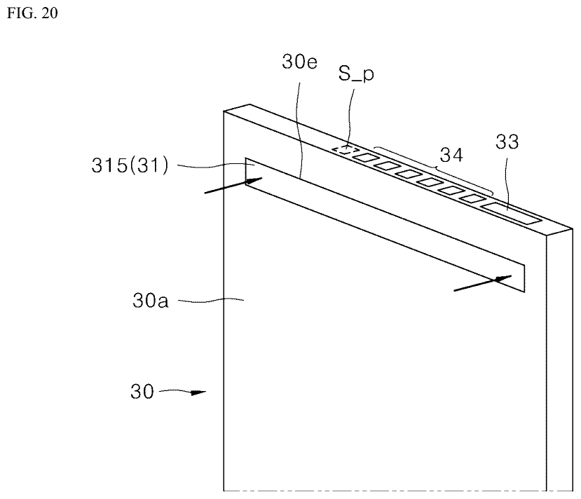

A detailed process of manually moving the pop-up handle 31 using the manual pop-up device 312 is described below with reference to FIG. 20.

FIGS. 16 to 19 illustrate an example detailed configuration of the manual pop-up device 312 accommodated in the handle body 311.

In a similar manner to the handle driver 35 as shown in FIG. 16, the manual pop-up device 312 may be provided as a pair of manual pop-up devices. A left-side manual pop-up device 312 and a right-side manual pop-up device 312 may be installed on and fixed to the second body 3112 of the handle body 311 while being in a symmetrical arrangement with each other around the handle body 311.

Therefore, both manual pop-up devices 312 may be configured to be identical with each other except for the symmetrical arrangement thereof.

Therefore, the following description will be based on the manual pop-up device 312 disposed at the left side. Unless otherwise described, the following descriptions may be equally applied to the manual pop-up device 312 disposed at the right side.

Each of the latch 3121 and the latch holder 3122 constituting the manual pop-up device 312 may be disposed and accommodated in the second body 3112 constituting the handle body 311, more specifically, in an inner hollow space of the second body 3112.

In this way, the latch 3121 and the latch holder 3122 constituting the manual pop-up device 312 are configured to be accommodated entirely in the inside of the second body 3112, such that increase in the size of the handle body 311 in the front-rear direction due to the addition of the manual pop-up device 312 may be effectively prevented.

More specifically, the latch 3121 may be directly fixed to the second body 3112 while being disposed in the inside of the second body 3112 of the handle body 311.

An inner panel 3112b that divides an inner space of the second body 3112 into a front space and a rear space may be disposed in the second body 3112 and may be integrally formed with the second body.

A flange 3121b of the latch 3121 may be fixed to a protruding surface 3112b1 of the inner panel 3112b of the second body 3112 using a fastening means such as a bolt or the like.

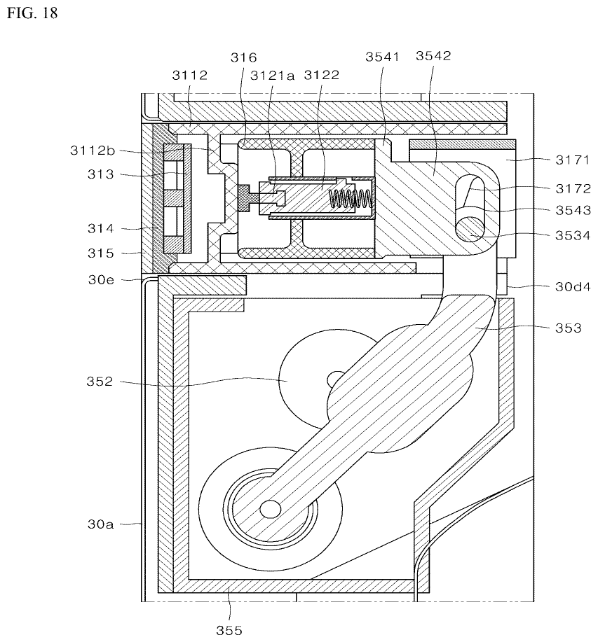

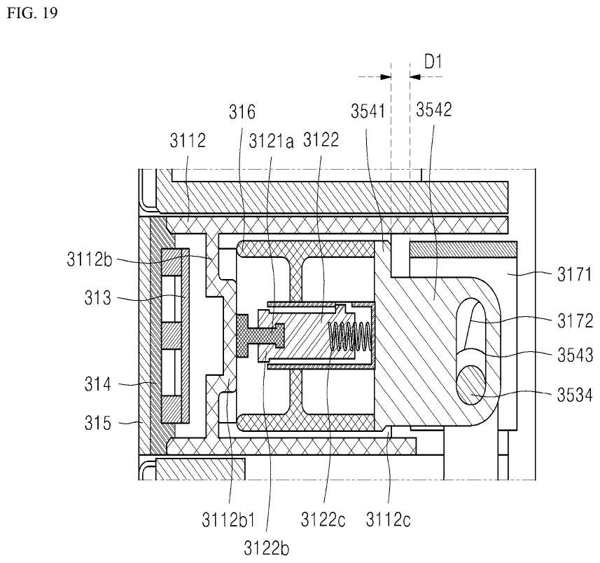

As shown in FIG. 18 and FIG. 19, the protruding surface 3112b1 of the inner panel 3112b may be configured to protrude toward the sliding block 316.

As described below, when the handle body 311 has been pressed toward the inside of the door 30 for manual pop-up and thus has moved relative to the sliding block 316 by a distance greater than the retract stroke, the protruding surface 3112b1 may enter the inside of the sliding block 316.

The flange 3121b of the latch 3121 may be fixed to the protruding surface 3112b1 that has entered the inside of the sliding block 316 during the manual pop-up, such that a relative movement stroke of the handle body 311 for canceling the engagement between the latch 3121 and the latch holder 3122 may be effectively secured while minimizing the size in the front-back direction of each of the latch 3121 and the latch holder 3122 and the size in the front-back direction of the sliding block 316.

In one example, the flange 3121b may be integrally formed with a latch protrusion 3121a that protrudes toward the latch holder 3122.

As illustrated, the latch protrusion 3121a may be configured to be caught with a catch arm 3122b included in the latch holder 3122. The latch protrusion 3121a may be formed to have a hook shape so that the engagement and disengagement between the latch protrusion 3121a and the catch arm 3122b may be easily implemented.

The latch holder 3122 may be fixedly disposed in the inside of the sliding block 316 accommodated in the second body 3112 so as to be relatively movable with respect to the second body 3112.

In a manner similar to the second body 3112, the sliding block 316 may be provided in a hollow shape. A coupling rib 3161 may be disposed inside the sliding block 316 and may be integrally formed therewith and may support and fix the latch holder 3122.

The latch holder 3122 may be forcibly coupled to the coupling rib 3161 by forcibly fitting a holder body 3122a of the latch holder 3122 into an inner space defined by the coupling rib 3161.

A front surface of the holder body 3122a may be entirely open, and a pair of catch arms 3122b may be configured to be movable in the forward and backward directions through the open front surface of the holder body 3122a.

A spacing between the pair of catch arms 3122b is gradually smaller as each of the catch arms extends toward the inside of the holder body 3122a.

Therefore, as the latch 3121 moves rearwards so as to be re-engaged the latch with the latch holder 3122, the latch protrusion 3121a presses the pair of catch arms 3122b to move the catch arms 3122b into the inside of the holder body 3122a. As the spacing between the pair of catch arms 3122b is gradually smaller as each of the catch arms extends toward the inside of the holder body 3122a, the latch protrusion 3121a may be caught with the pair of catch arms 3122b.

In one example, as shown in FIG. 18 and FIG. 19, the compression spring 3122c that presses the pair of catch arms 3122b in a direction so as to push the catch arms may be disposed inside the holder body 3122a.

As described above, the compression spring 3122c generates a force that causes the latch 3121 and the handle body 311 to bounce in the opposite direction to the direction of the pressing force, that is, toward the outside of the door 30.

In addition, other configurations of the manual pop-up device 312 may be known in the art, and therefore, a description of the other configurations will be omitted below.

In this way, the pop-up handle 31 of the dish washer 1 is configured so that the handle body 311 is manually popped up in a state where the handle body has been displaced to the retracted position Pa.

In some implementations, the pop-up handle may be configured to such that the handle body 311 may not pop up manually in a state where the user can grasp the pop-up handle 31, such as a state in which the handle 31 has moved from the retracted position Pa to the extended position Pd.

For example, when the handle 31 is configured so that the handle body 311 manually pops-up in a state in which the pop-up handle 31 has moved to the extended position Pd, the handle body 311 may be manually popped up even in a situation where the user does not want to do so. This is likely to cause inconvenience to the user.

In some examples, the pop-up handle 31 of the dish washer 1 may further include a pop-up blocker 317 configured to prevent the manual pop-up of the handle body 311 from occurring in a state in which the pop-up handle 31 has been displaced to the extended position Pd.

When the handle body 311 has been displaced to the extended position, the pop-up blocker 317 may be configured to limit the relative movement of the handle body 311 to the sliding block 316 so that the relative movement amount of the handle body 311 thereto greater than or equal to the retract stroke is not generated, thereby preventing the manual pop-up of the handle body.

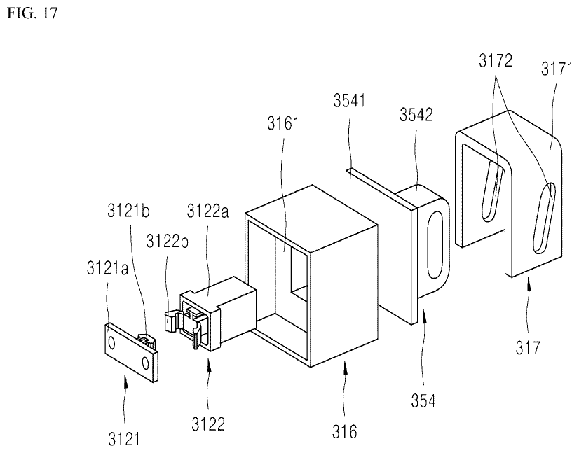

As shown in FIG. 17, the pop-up blocker 317 may be configured to include a body 3171 configured to move together with the link connector 354 when the handle driver 35 operates, and to limit the relative movement of the handle body 311 to be smaller than the retract stroke when the pop-up handle 31 has been displaced to the extended position Pd; and a pair of pin holes 3172 extending through the left and right side surfaces of the body 3171, respectively.

As shown, the body 3171 of the pop-up blocker 317 may be disposed in rear of the link connector 354, and may have a hollow box shape so that the link connection portion 3542 of the link connector 354 may be accommodated in the hollow space thereof.

Furthermore, in a similar manner to the link connector 354, the body 3171 of the pop-up blocker 317 may be accommodated in the inner space of the second body 3112.

In some examples, a front surface, a rear surface, and a bottom surface of the body 3171 of the pop-up blocker 317 may be entirely open so that interference thereof with the pivot link 353 that pivots when the handle driver 35 operates may be minimized.

Accordingly, the body 3171 of the pop-up blocker 317 may have a cross-section of a 90 degrees-rotated U shape.

A front edge of the body 3171 of the pop-up blocker 317 may function as a stopper that limits the relative movement of the handle body 311 with respect to the sliding block 316.

An inner surface of the second body 3112 may have a stopper protrusion 3112c formed thereon configured to collide with the front edge of the body 3171 of the pop-up blocker 317 when the handle body 311 moves relative to the sliding block 316.

The stopper protrusion 3112c may be formed on the inner surface of the second body 3112 and may extend in the front-back direction and may be positioned at each upper edge at which a top surface and each of both opposing side surfaces meet each other and each lower edge at which a lower surface and each of both opposing side surfaces meet each other, as shown in FIG. 18 and FIG. 19.

A rear end of the stopper protrusion 3112c is configured to collide with the front edge of the body 3171 of the pop-up blocker 317 according to the relative movement amount of the handle body 311, and thus, the relative movement of the handle body 311 may be limited due to this collision.

In some examples, a predetermined frontward-backward spacing may be formed between the rear end of the stopper protrusion 3112c and the front edge of the body 3171. This frontward-backward spacing may be set to vary depending on a position of the handle body 311.

That is, as shown in FIG. 18 and FIG. 19, when the pop-up handle 31 has been displaced to the retracted position Pa, a first spacing D1 along the frontward-backward direction may be defined between the rear end of the stopper protrusion 3112c and the front edge of the body 3171.

Furthermore, when the pop-up handle 31 has been displaced to the extended position Pd as described below, a second spacing D2 along the frontward-backward direction may be defined between the rear end of the stopper protrusion 3112c and the front edge of the body 3171.

The second spacing D2 may be larger than the first spacing D1. As the pop-up handle 31 is being displaced from the retracted position Pa to the extended position Pd, a frontward-backward spacing between the rear end of the stopper protrusion 3112c and the front edge of the body 3171 may gradually decrease from the first spacing D1 to the second spacing D2.

In some examples, the first spacing D1 may be larger than the retract stroke of the handle body 311.

Furthermore, the second spacing D2 may be smaller than the retract stroke of the handle body 311.

For example, the first spacing D1 may be in a range of 3 mm to 3.2 mm, and the second spacing D2 may be in a range of 0.5 mm to 1 mm.

In this way, the first spacing D1 is larger than the retract stroke of the handle body 311, and the second spacing D2 is smaller than the retract stroke of the handle body 311. Thus, the manual pop-up of the handle body 311 may be permitted at the retracted position Pa, while the manual pop-up of the handle body 311 may be blocked at the extended position Pd.

This is because the relative movement amount due to the pressing of the handle body 311 cannot be greater than or equal to the retract stroke at the extended position Pd.

The pin holes 3172 respectively defined in both opposing side surfaces of the body 3171 may allow the spacing in the front-back direction between the rear end of the stopper protrusion 3112c and the front edge of the body 3171 to be variable.

More specifically, as shown in FIG. 17 to FIG. 19, each of the pin holes 3172 respectively defined in both opposing side surfaces of the body 3171 may linearly extend similarly to the pin guide hole 3543 of the link connector 354.

Both opposing ends of the connection pin 3534 may be respectively inserted into the pin holes 3172.

Therefore, when the handle driver 35 operates, the connection pin 3534 moves in the vertical direction in a state in which the connection pin 3534 has been simultaneously inserted into the pin guide holes 3543 and the pin holes 3172.

However, the extension direction of the pin hole 3172 may be oriented to define an intersection angle with respect to the extension direction of the pin guide hole 3543.

That is, while the pin guide hole 3543 extends along the vertical direction at an approximately upright manner, the pin hole 3172 of the pop-up blocker 317 may extend at an inclination angle at which the pin hole tilts in the rearward direction.

Accordingly, a distance between the pin hole 3172 and the front edge of the body 3171 gradually increases as the pin hole 3172 extends from the bottom to the top of the pin hole 3172.

In this way, the extension direction of the pin hole 3172 is oriented to define the inclined angle or the intersection angle with respect to the extension direction of the pin guide hole 3543. Thus, the spacing in the front-back direction between the rear end of the stopper protrusion 3112c and the front edge of the body 3171 may vary in conjunction with the movement of the connection pin 3534.

More specifically, as shown in FIG. 18 and FIG. 19, when the pop-up handle 31 is driven to move from the retracted position Pa toward the extended position Pd, the connection pin 3534 which has been located at the bottom of the pin guide hole 3543 and the bottom of the pin hole 3172 moves upwardly.

As the connection pin 3534 moves upwards, the pop-up blocker 317 and the link connector 354 move together toward the extended position Pd such that the pop-up blocker 317 moves by a relatively movement amount than a movement amount of the link connector 354 due to the inclination angle of the pin hole 3172.

That is, a relative movement between the pop-up blocker 317 and the link connector 354 occurs, and accordingly, the spacing in the front-back direction between the rear end of the stopper protrusion 3112c and the front edge of the body 3171 may be gradually reduced.

This gradually reduced spacing has reached the second spacing D2 when the pop-up handle 31 has moved to the extended position Pd, and accordingly, the handle body 311 may be brought into a state where the manual pop-up thereof is prevented.

Hereinafter, referring to FIGS. 20 to 23, the process of manually popping up the handle body 311 at the retracted position Pa and the process of retracting the manually popped-up handle body 311 to an original position will be described.

In some implementations, referring to FIG. 20, as described above, the manual pop-up device 312 may be provided as a pair of manual pop-up devices 312. The left-side manual pop-up device 312 and the right-side manual pop-up device 312 may be respectively installed on and fixed to the left and right second bodies 3112 that constitute the handle body 311.

Therefore, in order to manually pop-up the pop-up handle 31 stopped at the retracted position Pa, the user should press both opposing ends of the handle body 311 to retract the handle body 311 toward the inside of the door 30.

In some examples, when the both opposing ends of the handle body 311 are pressed individually and sequentially, there is a possibility that the handle body 311 will not pop up effectively.

Therefore, when the both opposing ends of the handle body 311 are pressed simultaneously such that the handle body 311 is retracted toward the inside of the door 30 such that the handle body 311 has a movement amount greater than or equal to the retract stroke. Thus, the handle body 311 may pop up toward the outside of the door 30, i.e., in the frontward direction, under the action of the compression spring 3122c of the manual pop-up device 312 as described above.

In this way, the handle body 311 can pop up only when the both opposing ends of the handle body 311 are pressed simultaneously. Thus, an effect of preventing the handle body 311 from popping up regardless of the user's intention may be achieved.

When the handle body 311 has popped up by the manual pop-up device 312 due to the user's pressure, the decoration panel 315 and light-guide plate 314 constituting a front end surface of the pop-up handle 31 may protrude outwardly from the front panel 30a of the door 30.

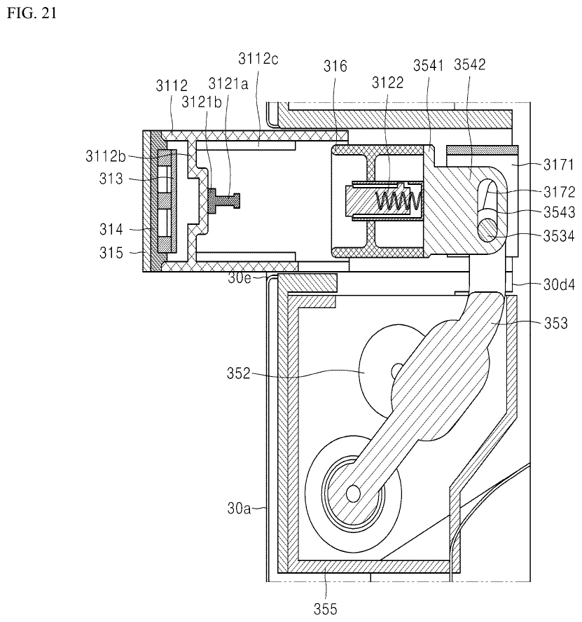

In this way, the front portion of the pop-up handle 31 partially protrudes outwardly from the front panel 30a of the door 30, such that the user may manually move the handle body 311 to the extended position Pd using a finger or a tool as shown in FIG. 21.

The user may effectively open the door 30 while grasping the handle body 311 moved to the extended position Pd and pulling the handle body 311 in the frontward direction.

In some implementations, because the connection between the latch 3121 and the latch holder 3122 has been cancelled as shown in FIG. 21, the sliding block 316 disposed inside the handle body 311 may not move while only the handle body 311 may move relative thereto and to the extended position Pd.

That is, the sliding block 316, the link connector 354, and the pop-up blocker 317 may be maintained in a stopped state at the retracted position Pa.

Further, the manually popped-up handle body 311 may be moved back to the original retracted position Pa by the user simply pushing the handle body 311 toward the inside of the door 30.

In some implementations, when the user pushes and moves the handle body 311 to the retracted position Pa and then applies a pressure to retract the handle body 311 by the retract stroke, the latch 3121 may be re-engaged with the latch holder 3122, and the handle body 311 may be re-coupled to the sliding block 316 via the manual pop-up device 312.

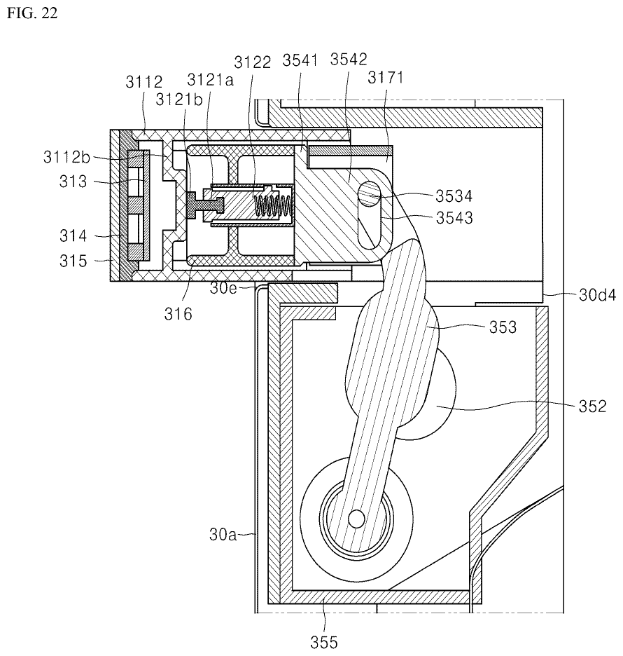

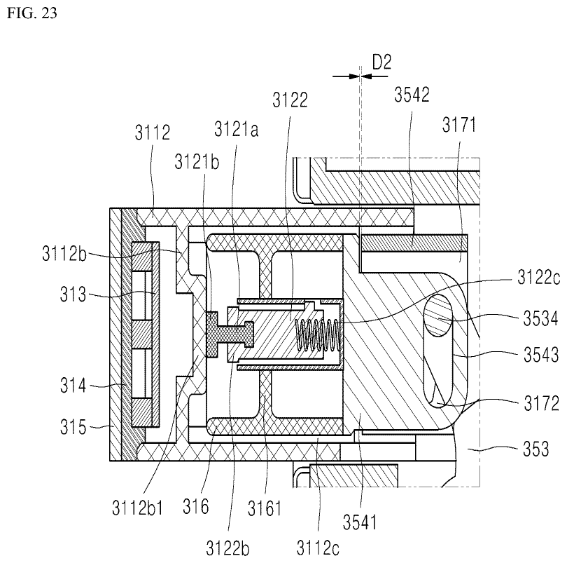

FIG. 22 and FIG. 23 illustrate the state in which the handle body 311 and the sliding block 316 have been moved together to the extended position Pd under the operation of the handle driver 35 and have been stopped.

When the sliding block 316, the link connector 354, and the pop-up blocker 317 are moved together with the handle body 311 in the frontward direction to the extended position Pd, the second spacing D2 along the frontward-backward direction may be defined between the rear end of the stopper protrusion 3112c disposed on the inner surface of the second body 3112 and the front edge of the pop-up blocker 317.

In some implementations, as described above, the second spacing D2 is much smaller than the retract stroke for cancelling the coupling between the latch 3121 and the latch holder 3122. Thus, even when a pressing force toward the inside of the door 30 is applied to the handle body 311, the relative movement of the handle body 311 is not greater than or equal to the second spacing D2.

Therefore, the disconnection between the latch 3121 and the latch holder 3122 does not occur, and accordingly, the state in which the manual pop-up of the handle body 311 is prevented may be maintained.

Although the implementations of the present disclosure have been described in more detail with reference to the accompanying drawings, the present disclosure is not necessarily limited to these implementations, and may be modified in a various manner within the scope of the technical spirit of the present disclosure. Accordingly, the implementations as disclosed in the present disclosure are intended to describe rather than limit the technical idea of the present disclosure, and the scope of the technical idea of the present disclosure is not limited by these implementations. Therefore, it should be understood that the implementations described above are not restrictive but illustrative in all respects. In addition, even though an effect of a configuration of the present disclosure is not explicitly described in describing the implementation of the present disclosure above, it is obvious that the predictable effect from the configuration should be recognized.

What is claimed is:

1. A dish washer comprising:
a tub that defines a washing space configured to accommodate one or more objects to be washed therein, the tub having an open front surface in fluid communication with the washing space;
a door configured to open and close the open front surface of the tub;
a handle configured to reciprocate between (i) an extended position in which the handle protrudes forward from the door and (ii) a retracted position in which the handle is accommodated within the door;
a handle driver disposed within the door and configured to reciprocate the handle from the retracted position toward the extended position or from the extended position toward the retracted position; and
a pop-up device configured to, based on the handle being stopped at the retracted position, move the handle to a pop-up position in which the handle at least partially protrudes from an inside of the door toward an outside of the door,
wherein the pop-up device is configured to, based on the handle being retracted rearwardly toward the inside of the door by a predetermined retract stroke from the retracted position, move the handle to the pop-up position.

2. The dish washer of claim 1, wherein the handle comprises:
a handle body configured to reciprocate between the extended position and the retracted position based on a driving force of the handle driver; and
a sliding block connected to the handle body and configured to move relative to the handle body, the sliding block being configured to transmit the driving force of the handle driver to the handle body,
wherein the pop-up device is configured to, based on the handle being retracted rearwardly by the predetermined retract stroke from the retracted position, move the handle body relative to the sliding block in a frontward direction toward the outside of the door to thereby pop up the handle body relative to a surface of the door.

3. The dish washer of claim 2, wherein the pop-up device comprises:
a latch fixed to the handle body; and
a latch holder fixed to the sliding block and removably coupled to the latch, and
wherein the latch holder comprises a compression spring configured to press the latch in the frontward direction toward the outside of the door.

4. The dish washer of claim 3, wherein the compression spring is configured to, based on the handle body moving relative to the sliding block rearwards toward the inside of the door by the predetermined retract stroke, push and move the latch in the frontward direction toward the outside of the door.

5. The dish washer of claim 4, wherein the pop-up device is configured to release an engagement between the latch and the latch holder before the latch moves in the frontward direction by force from the compression spring.

6. The dish washer of claim 5, wherein the latch and the latch holder are configured to be re-engaged with each other based on the handle body being retracted rearwards toward the inside of the door.

7. The dish washer of claim 6, wherein the latch and the latch holder are configured to, based on being re-engaged with each other, restrict the handle body from moving relative to the sliding block in the frontward direction toward the outside of the door.

8. The dish washer of claim 3, wherein the handle body comprises:
a first body that extends in a left-right direction and is configured to be gripped by a user; and
a second body that extends rearwards from the first body and defines an inner space configured to receive the sliding block therein,
wherein the second body comprises an inner panel that is disposed in the inner space and that divides the inner space into a front space and a rear space, the inner panel having a protruding surface that is convex toward the sliding block, and
wherein the latch is fixed to the protruding surface.

9. The dish washer of claim 8, wherein the latch holder is fixedly disposed in an interior space of the sliding block.

10. The dish washer of claim 9, wherein the protruding surface is configured to be retracted into the interior space of the sliding block based on the handle body being moved rearwards relative to the sliding block toward the inside of the door by the predetermined retract stroke.

11. The dish washer of claim 2, wherein the handle further comprises a pop-up blocker configured to allow the handle body to pop up relative to the surface of the door and to restrict the handle body from popping up relative to the surface of the door,
wherein the pop-up blocker is configured to:
based on the handle being moved to the retracted position, allow the handle body to pop up relative to the surface of the door, and
based on the handle being moved to the extended position, restrict the handle body from popping up relative to the surface of the door.

12. The dish washer of claim 11, wherein the pop-up blocker is disposed inside the handle body and configured to move relative to the handle body,
wherein the handle body comprises a stopper protrusion that is disposed at an inner surface of the handle body and positioned in front of the pop-up blocker, the stopper protrusion being spaced apart from the pop-up blocker,
wherein the stopper protrusion is configured to limit a relative movement of the handle body relative to the pop-up blocker, and
wherein the handle body is configured to, based on the handle being moved to the retracted position, define a first spacing between the stopper protrusion and the pop-up blocker in a frontward-backward direction.

13. The dish washer of claim 12, wherein a width of the first spacing is greater than the predetermined retract stroke.

14. The dish washer of claim 12, wherein the handle body is configured to, based on the handle being moved to the extended position, define a second spacing between the stopper protrusion and the pop-up blocker in the frontward-backward direction.

15. The dish washer of claim 14, wherein a width of the second spacing is less than the predetermined retract stroke.

16. The dish washer of claim 1, wherein handle driver is configured to, based a user being detected within a predetermined range from the door, move the handle from the retracted position to the extended position.

17. The dish washer of claim 1, wherein the pop-up device is configured to, based on a user pressing the handle at the retracted position, move the handle from the retracted position to the pop-up position.

18. The dish washer of claim 1, wherein the pop-up position is the extended position.

19. The dish washer of claim 1, wherein the handle is configured to be flush with a front surface of the door based on the handle being disposed at the retracted position.

20. The dish washer of claim 1, wherein the pop-up device is one of a plurality of pop-up devices that are disposed at lateral end portions of the handle.
